(19) United States
(12) Patent Application Publication
(10) Pub. No.: US 2009/0122040 A1
(43) Pub. Date: May 14, 2009

(54) DRIVE DEVICE AND DRIVE METHOD

(76) Inventors: Tsutomu Sakakibara, Shiga (JP); Kenji Miyake, Shiga (JP); Toru Matsugi, Osaka (JP); Kazunari Kaitani, Osaka (JP); Kazunori Inoue, Osaka (JP)

Correspondence Address: MCDERMOTT WILL & EMERY LLP, 600 13TH STREET, NW, WASHINGTON, DC, 20005-3096, US

(21) Appl. No.: 10/585,512

(22) PCT Filed: Nov. 8, 2005
(86) PCT No.: PCT/JP05/20469

§ 371 Date: Jul. 10, 2006

(30) Foreign Application Priority Data
Nov. 10, 2004 (JP) 2004-326563

(51) Int. Cl. G09G 5/00

(52) U.S. Cl. 345/208

(57) ABSTRACT

A first generation section (106) sequentially turns k first signals to the output state. A second generation section (107) sequentially turns m second signals to the output state. A total of (k×m) output circuits (X1 to Xkm) are divided into k groups. Each of the k groups includes m output circuits. The k first signals correspond to the k groups, and the m second signals correspond to the m output circuits belonging to each of the k groups. Each of the (k×m) output circuits outputs its corresponding second signal when the second signal is turned to the output state if the first signal corresponding to the group to which the output circuit belongs is in the output state.

### TECHNICAL FIELD

The present invention relates to a drive device and drive method for sequentially outputting a plurality of output signals, and more particularly, to a drive device and drive method for driving scanning lines to which a plurality of display elements are connected in a display apparatus such as a liquid crystal display panel and an organic EL panel.

### BACKGROUND ART

FIG. 29 is a block diagram showing a conventional drive device (for example, Japanese Laid-Open Patent Publication No. 2000-98339). This device is used as a scanning line driver for a liquid crystal display panel, for example. The conventional drive device includes: a shift register 10 composed of n flipflops FF-1 to FF-n (n is a positive integer); n level shifters LS-1 to LS-n for shifting the level of n outputs from the shift register 10; and an output circuit 20 composed of n output buffers OB-1 to OB-n. The n output buffers OB-1 to OB-n output n drive signals SX1 to SXn.

The operation of the drive device shown in FIG. 29 will be described with reference to FIG. 30.

First, data (a start pulse) is input at a terminal 11. The flipflop FF-1 captures the start pulse according to a clock input at a terminal 12. The flipflop FF-1 outputs a high-level signal of one pulse from its terminal Y in synchronization with the rising edge of the clock. The flipflop FF-1 also outputs the data from its terminal Q to be input into the terminal D of the next flipflop FF-2. In this way, the data is sequentially handed over among the n flipflops FF-1 to FF-n, and a high-level signal of one pulse is output from the terminal Y of each of the n flipflops FF-1 to FF-n. These high-level signals are then level-shifted to signals having an amplitude difference of VGG-VEE with the n level shifters LS-1 to LS-n. The level-shifted signals are then buffered with the n output buffers OB-1 to OB-n, to be output as the n drive signals SX1 to SXn. Thus, with the sequential output of the n signals from the shift register 10, the drive signals SX1 to SXn are sequentially output.

For example, when the above drive device is used as a scanning line driver for a liquid crystal display panel, a plurality of scanning electrode lines are sequentially activated with these drive signals SX1 to SXn, to scan the display screen of the liquid crystal display panel in the vertical direction.

### Patent Literature 1: Japanese Laid-Open Patent Publication No. 2000-98339

### DISCLOSURE OF THE INVENTION

### Problems to be Solved by the Invention

In recent years, drive devices have come to be asked for increasing the number of outputs and reducing cost. In conventional drive devices, however, increasing the number of outputs will lead to increase of the circuit scale and hence higher cost.

For example, with the demands for higher definition of liquid crystal display panels, scanning line drivers have come to be asked for providing more outputs. Such demands for higher definition have come to be made for small-size liquid crystal panels such as those used for mobile phones, as having been made for large-scale liquid crystal display panels.

Also, in order to achieve easy installation of driver ICs such as scanning line drivers and data drivers into liquid crystal display panels and cost reduction, single-chip driver ICs are becoming the mainstream in liquid crystal display panels for mobile phones. With attainment of higher definition of liquid crystal display panels and single-chip driver ICs, the chip area of a driver IC becomes very large and this increases the cost of the resultant liquid crystal display panel. That is, since a driver IC has a display controller, a graphic RAM, a data driver and a scanning line driver mounted thereon, the circuit scale increases as the definition is higher. Generally, therefore, transistors are made finer in the semiconductor fabrication process to reduce the circuit area of the driver IC.

However, reducing the circuit scale by providing finer transistors has a limitation. In general, the specifications of drive signals to be supplied to a liquid crystal display panel are determined with the characteristics of the liquid crystal display panel. For example, to drive liquid crystal display elements (generally, elements each composed a thin film transistor (TFT) and a liquid crystal capacitance) on a liquid crystal display panel for mobile phones, a drive signal having a potential difference of “about +15 V” as ON potential (VGG) and “about −15 V” as OFF potential (VEE) is necessary as the drive voltage required for a scanning line driver. Accordingly, the scanning line driver for supplying the drive signal must be composed of transistors having a breakdown voltage responsive to the drive signal. The breakdown voltage of a transistor decreases as the gate length of the transistor is reduced. Therefore, providing finer transistors has a limitation.

In view of the above, an object of the present invention is reducing the circuit scale of a drive device.

### Means for Solving the Problems

According to one aspect of the invention, the drive device includes first and second generation sections and (k×m) output circuits. The first generation section sequentially turns k first signals from a non-output state to an output state according to a first clock, where k is a natural number. The second generation section sequentially turns m second signals from the non-output state to the output state according to a second clock, where m is a natural number. The (k×m) output circuits are divided into k groups, and m output circuits belong to each of the k groups. The k first signals correspond to the k groups. The m second signals correspond to the m output circuits belonging to each of the k groups. Each of the (k×m) output circuits outputs its corresponding second signal when the second signal is turned to the output state if the first signal corresponding to the group to which the output circuit belongs is in the output state. Each of the (k×m) output circuits does not output its corresponding second signal even when the second signal is in the output state if the first signal corresponding to the group to which the output circuit belongs is in the non-output state.

In the drive device described above, by combining the first generation section having k outputs and the second generation section having m outputs, a total of (k×m) drive signals are sequentially output. That is, the number of outputs in the upstream part of the drive device can be reduced, and thus the circuit scale of the drive device can be reduced.

Preferably, the second generation section sequentially turns the m second signals from the non-output state to the output state according to the second clock during the time when any one of the k first signals is in the output state.

Preferably, each of the (k×m) output circuits includes an output terminal, a first input terminal, a first switch, a second input terminal and a second switch. The first input terminal receives the second signal corresponding to the output circuit. The first switch is connected between the output terminal and the first input terminal and switches ON/OFF according to the state of the first signal corresponding to the output circuit. The second input terminal receives a predetermined voltage corresponding to the non-output state of the second signal. The second switch is connected between the output terminal and the second input terminal and switches ON/OFF according to the state of the first signal corresponding to the output circuit.

Preferably, the first generation section includes k first flipflops connected in series. The second generation section includes m second flipflops connected in series.

Preferably, the drive device further includes a logic circuit. The logic circuit is connected between the first generation section and the (k×m) output circuits and receives an external control signal. The logic circuit turns all of the k first signals from the first generation section to the non-output state simultaneously according to existence/absence of the control signal.

In the drive device described above, the output from the (k×m) output circuits can be restricted with the control signal. This makes it possible to display only a predetermined line (or update the image displayed on a predetermined line) in a liquid crystal display panel, for example. In other words, a partial display function can be attained.

Preferably, the drive device further includes a logic circuit. The logic circuit is connected between the second generation section and the (k×m) output circuits and receives an external control signal. The logic circuit-turns all of the m second signals from the second generation section to the non-output state simultaneously according to existence/absence of the control signal.

Preferably, the drive device further includes first and second selectors. The first selector is connected between the s-th first flipflop from the top and the (s+1)th first flipflop among the k first flipflops, where s is a natural number and 1≦s≦(k−2). The second selector is connected between the t-th first flipflop from the top and the (t+1)th first flipflop among the k first flipflops, where t is a natural number and s≦t≦(k−1). The first and second selectors have first and second modes. In the first mode, the first selector outputs an output from the s-th first flipflop to the (s+1)th first flipflop. The second selector outputs an output from the t-th first flipflop to the (t+1)th first flipflop. In the second mode, the first selector outputs the output from the s-th first flipflop to the second selector. The second selector outputs an output from the first selector to the (t+1)th first flip-flop.

In the drive device described above, the output from the (k×m) output circuits can be restricted by changing the operation mode of the selector. This makes it possible not to display only a predetermined line (or not to update the image displayed on a predetermined line) in a liquid crystal display panel, for example. In other words, a partial display function can be attained.

Preferably, the drive device further includes a selection circuit having first and second modes. In the first mode, the selection circuit outputs an output from the y-th second flipflop from top among the m second flipflops as the y-th second signal, and outputs an output from the (y+1)th second flipflop as the (y+1)th second signal, where y is an odd natural number and m is an even natural number, where 1≦y≦(m−1). In the second mode, the selection circuit outputs the output from the y-th second flipflop as the y-th and (y+1)th second signals, and does not output the output from the (y+1)th second flip-flop.

In the drive device described above, a plurality of drive signals can be output simultaneously depending on the operation mode of the selector. For example, a plurality of lines can be made active simultaneously in a liquid crystal display panel.

Preferably, the drive device further includes a logic circuit. The logic circuit is connected between the first generation section and the (k×m) output circuits and receives an external control signal. The logic circuit turns all of the k first signals from the first generation section to the output state simultaneously according to existence/absence of the control signal.

In the drive device described above, a plurality of drive signals can be output simultaneously. For example, in a liquid crystal display panel, a plurality of lines can be made active simultaneously.

Preferably, the drive device further includes a logic circuit. The logic circuit is connected between the second generation section and the (k×m) output circuits and receiving an external control signal. The logic circuit turns all of the m second signals from the second generation section to the output state simultaneously according to existence/absence of the control signal.

Preferably, the drive device further includes a logic circuit. The logic circuit is connected between the first generation section and the (k×m) output circuits and operates according to existence/absence of an external control signal. The control signal is output for a predetermined duration in the time period from the time when any one of the m second signals is turned to the output state until the time when the next second signal is turned to the output state, the predetermined duration being shorter than the time period. Once receiving the control signal, the logic circuit turns all of the k first signals from the first generation section to the non-output state simultaneously.

In the drive device described above, when a given drive signal is being output, output of any other drive signal that is essentially unnecessary can be prevented. This can prevent such an occurrence that when an image is being written on a given line in a liquid crystal display panel, an image may mistakenly be written on a line different from the given line.

Preferably, the drive device further includes a logic circuit. The logic circuit is connected between the second generation section and the (k×m) output circuits and operates according to existence/absence of an external control signal. The control signal is output for a predetermined duration in the time period from the time when any one of the m second signals is turned to the output state until the time when the next second signal is turned to the output state, the predetermined duration being shorter than the time period. Once receiving the control signal, the logic circuit turns all of the m second signals from the second generation section to the non-output state simultaneously.

Preferably, the drive device further includes a logic circuit. The logic circuit is connected between the first and second generation sections and the (k×m) output circuits and receives an external control signal. The logic circuit turns all the k first signals from the first generation section to the output state simultaneously and also turns all the m second signals from the second generation section to the output state simultaneously, according to existence/absence of the control signal.

In the drive device described above, for example, all gate lines of a display panel can be activated simultaneously. This makes it possible to release charge stored in liquid crystal elements of the display panel at a time.

Preferably, each of the (k×m) output circuits receives an external control signal. Each of the (k×m) output circuits further includes a selection section. The selection section outputs either the signal supplied at the output terminal or a predetermined voltage corresponding to the output state of the second signal.

According to another aspect of the invention, the drive method sequentially outputs drive signals from (k×m) output terminals divided into k groups, where k and m are natural numbers, and m output terminals belong to each of the k groups. According to a first clock, k first signals corresponding to the k groups are sequentially turned from a non-output state to an output state. According to a second clock, m second signals corresponding to the m output terminals belonging to each of the k groups are sequentially turned from the non-output state to the output state. In each of the (k×m) output terminals, the second signal corresponding to the output terminal is output from the output terminal as the drive signal when the second signal is turned to the output state if the first signal corresponding to the group to which the output terminal belongs is in the output state. In each of the (k×m) output terminals, the second signal corresponding to the output terminal is not output from the output terminal as the drive signal even when the second signal is in the output state if the first signal corresponding to the group to which the output terminal belongs is in the non-output state.

### EFFECT OF THE INVENTION

As described above, by combining the first generation section having k outputs and the second generation section having m outputs, a total of (k×m) drive signals are sequentially output. That is, the number of outputs in the upstream part of the drive device can be reduced, and thus the circuit scale of the drive device can be reduced.

### BRIEF DESCRIPTION OF THE DRAWINGS

FIG. 1 is a block diagram showing the entire configuration of a drive device of the first embodiment of the present invention.

FIG. 2 is a circuit diagram showing an internal configuration of an output circuit shown in FIG. 1.

FIG. 3 is a timing chart for demonstrating the operation with the drive device shown in FIG. 1.

FIG. 4 is a block diagram showing the entire configuration of a drive device of the second embodiment of the present invention.

FIG. 5 is a timing chart for demonstrating the operation with the drive device shown in FIG. 4.

FIG. 6 is a block diagram showing an alteration to the drive device shown in FIG. 4.

FIG. 7 is a block diagram showing an alteration to the drive device shown in FIG. 4.

FIG. 8 is a block diagram showing an alteration to the drive device shown in FIG. 4.

FIG. 9 is a block diagram showing an alteration to the drive device shown in FIG. 4.

FIG. 10 is a block diagram showing an alteration to the drive device shown in FIG. 4.

FIG. 11 is a block diagram of an internal configuration of a signal generation section used in the third embodiment of the present invention.

FIG. 12 is a timing chart for demonstrating the operation with a drive device of the third embodiment of the present invention.

FIG. 13 is a block diagram showing the entire configuration of a drive device of the fourth embodiment of the present invention.

FIG. 14 is a timing chart for demonstrating the operation with the drive device shown in FIG. 13.

FIG. 15 is a block diagram showing an alteration to the drive device shown in FIG. 13.

FIG. 16 is a block diagram showing the entire configuration of a drive device of the fifth embodiment of the present invention.

FIG. 17 is a timing chart for demonstrating the operation with the drive device shown in FIG. 16.

FIG. 18 is a block diagram showing an alteration to the drive device shown in FIG. 16.

FIG. 19 is a block diagram showing an alteration to the drive device shown in FIG. 16.

FIG. 20 is a timing chart for demonstrating the operation with the drive device shown in FIG. 19.

FIG. 21 is a block diagram showing an alteration to the drive device shown in FIG. 16.

FIG. 22 is a block diagram showing the entire configuration of a drive device of the sixth embodiment of the present invention.

FIG. 23 is a timing chart for demonstrating the operation with the drive device shown in FIG. 22.

FIG. 24 is a block diagram showing an alteration to the drive device shown in FIG. 22.

FIG. 25 is a block diagram showing the entire configuration of a drive device of the seventh embodiment of the present invention.

FIG. 26 is a timing chart for demonstrating the operation with the drive device shown in FIG. 25.

FIG. 27 is a block diagram showing the entire configuration of a drive device of the eighth embodiment of the present invention.

FIG. 28 is a circuit diagram showing an internal configuration of an output circuit shown in FIG. 27.

FIG. 29 is a block diagram showing the entire configuration of a conventional drive device.

FIG. 30 is a timing chart for demonstrating the operation with the drive device shown in FIG. 29.

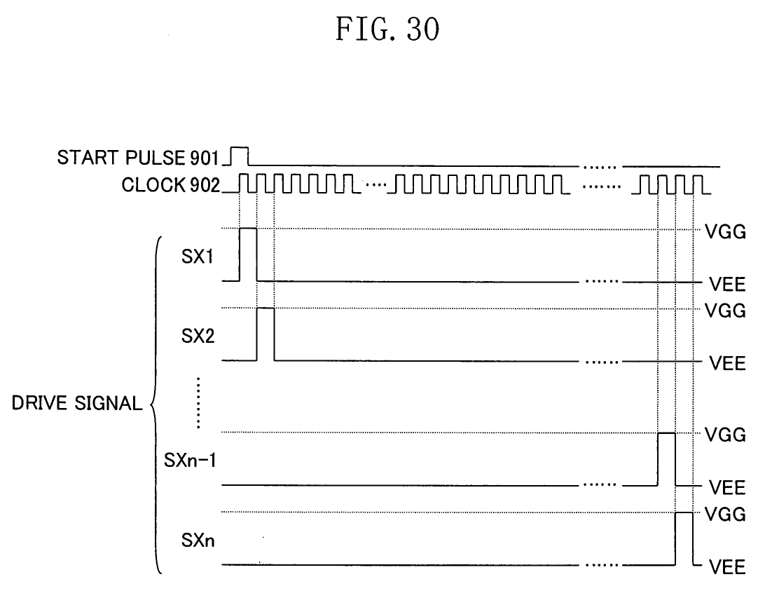

### DESCRIPTION OF REFERENCE NUMERALS

101 Drive signal input terminal
102 Clock input terminal
103 Reset signal input terminal
104, 105, 402 Frequency divider circuits
106, 107 Signal generation sections
108 Output section
116, 117 Shift registers
FFa-1 to FFa-k, FFb-1 to FFb-m Flip-flops
LSa-1 to LSa-k, LSb-1 to LSb-m Level shifters
OBa-1 to OBa-k, OBb-1 to OBb-m Output buffers
X1 to Xkm Output circuit
120s Data signal input terminal
120b Enable signal input terminal
121 OFF voltage input terminal
MN124, MP124, MN125 Transistors
OUT Output terminal
200, 500, 600, 700, 800 Control signal input terminals
201, 501, 601 Logic circuits
201-1 to 201-k, 201-1 to 201-m AND circuits
301, 302, 401-1 to 401-p, 403-1 to 403-p Selectors
501-1 to 501-k, 501-1 to 501-m, 701a-1 to 701a-k, 701b-1 to 701b-m OR circuits
601-1 to 601-k, 601-1 to 601-m NOR circuits
80 Selection circuit
81 Selection section
82 Inverter
MN83, MP83, MN84 Transistors
85 ON voltage input terminal
OUT′ Output terminal

### BEST MODE FOR CARRYING OUT THE INVENTION

Hereinafter, embodiments of the present invention will be described in detail with reference to the drawings. In the drawings, identical or corresponding components are denoted by the same reference numerals, and the description thereof is not repeated.

### FIRST EMBODIMENT

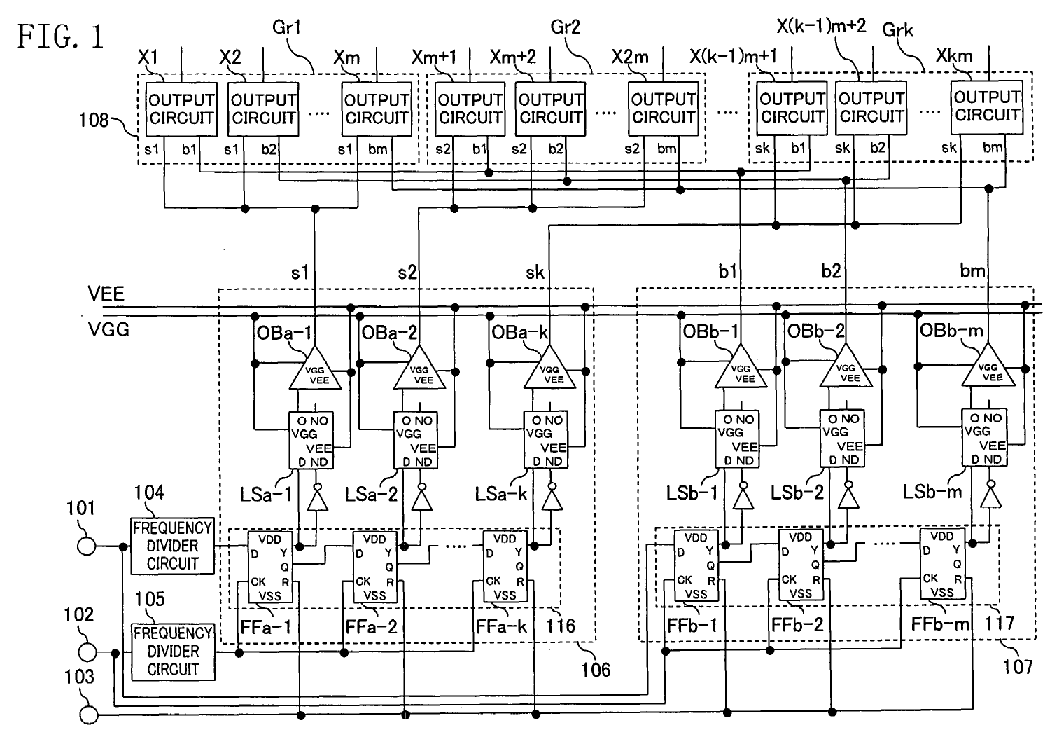

FIG. 1 shows a configuration of a drive device of the first embodiment of the present invention. This device is used as a scanning line driver of a liquid crystal display panel, for example. The device includes a drive signal input terminal 101, a clock input terminal 102, a reset signal input terminal 103, frequency dividers 104 and 105, signal generation sections 106 and 107, and an output section 108. The drive signal input terminal 101 receives an external drive signal (start pulse). The clock input terminal 102 receives an external clock. The reset signal input terminal 103 receives an external reset signal. The frequency divider 104 divides the start pulse input at the drive signal input terminal 101 by a predetermined number of cycles. The frequency divider 105 divides the clock input at the clock input terminal 102 by a predetermined number of cycles. The signal generation section 106 outputs k enable signals s1 to sk (k is a natural number) according to the start pulse frequency-divided by the frequency divider 104 and the clock frequency-divided by the frequency divider 105. The signal generation section 107 outputs m data signals b1 to bm (m is a natural number) according to the start pulse input at the drive signal input terminal 101 and the clock input at the clock signal input terminal 120.

<Internal Configuration of Output Sections>

The output section 108 includes (k×m) output circuits. The (k×m) output circuits are divided into k groups Gr1 to Grk, each of which has m output circuits. For example, m output circuits X1 to Xm belong to the group Gr1, m output circuits Xm+1 to X2m belong to the group Gr2, and m output circuits X(k−1)m+1 to Xkm belong to the group Grk.

The k groups Gr1 to Grk correspond to the k enable signals s1 to sk, where the group Gr1 corresponds to the enable signal s1, the group Gr2 corresponds to the enable signal s2, and the group Grk corresponds to the enable signal sk.

The m output circuits belonging to each of the groups Gr1 to Grk correspond to the m data signals b1 to bm, where the output circuits X1, Xm+1, X(k−1)m+1 correspond to the data signal b1, the output circuits X2, Xm+2, X(k−1)m+2 correspond to the data signal b2, and the output circuits Xm, X2m, Xkm correspond to the data signal bm.

Each of the (k×m) output circuits outputs a drive signal according to the enable signal corresponding to the group to which the output circuit belongs and its corresponding data signal.

<Relationship Among Output Circuits, Enable Signals and Data Signals>

The relation among the output circuits, the enable signals and the data signals will be described concretely. Assume herein that m=16 and k=20. First, 320 output circuits are divided into a total of 20 groups each having 16 output circuits. Specifically, the output circuits X1 to X16 belong to the group Gr1, the output circuits X17 to X32 belong to the group Gr2, and the output circuits X305 to X320 belong to the group Gr20.

The enable signals s1 to s20 from the signal generation section 106 are connected to the 320 output circuits. Specifically, the enable signal s1 is connected to the output circuits X1 to X16 belonging to the group Gr1, and the enable signal s2 is connected to the output circuits X17 to X32 belonging to the group Gr2. The subsequent enable signals are connected in the same way up to the enable signal s20 that is connected to the output circuits X305 to X320 belonging to the group Gr20.

The data signals b1 to b16 from the signal generation section 107 are connected to the 320 output circuits. Specifically, the data signal b1 is connected to the output circuits X1, X17, . . . , X305 smallest in number among the 16 output circuits belonging to each of the groups Gr1 to Gr20. The data signal b2 is connected to the output circuits X2, X18, . . . , X306 second smallest in number among the 16 output circuits belonging to each of the groups Gr1 to Gr20. The subsequent data signals are connected in the same way up to the data signal b16 that is connected to the output circuits X16, X32, . . . , X320 largest in number among the 16 output circuits belonging to each of the groups Gr1 to Gr20.

<Internal Configuration of Output Circuits>

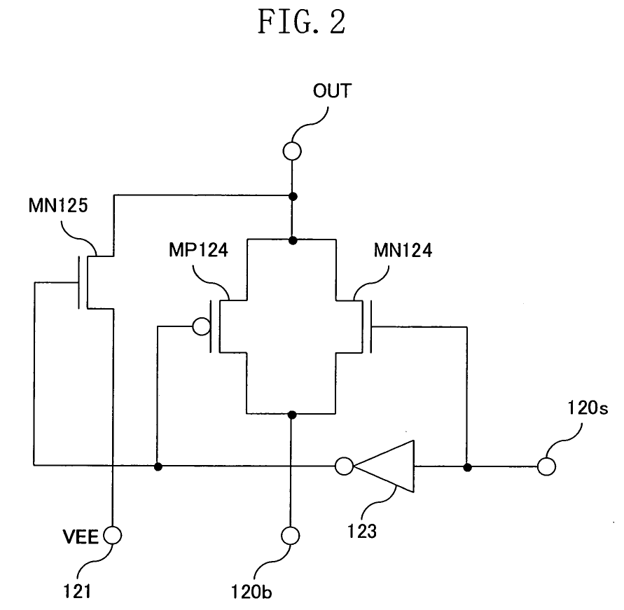

FIG. 2 shows an internal configuration of one output circuit shown in FIG. 1. The output circuit includes an enable signal input terminal 120s, a data signal input terminal 120b, an OFF voltage input terminal 121, an output terminal OUT, an inverter 123, and transistors MN124, MP124 and MN125. The enable signal input terminal 120s receives the enable signal corresponding to this output circuit. The data signal input terminal 120b receives the data signal corresponding to this output circuit. The OFF voltage input terminal 121 receives the reference voltage VEE. The transistors MN124 and MP124 constitute a transfer gate. The transistor MN124 is connected between the data signal input terminal 120b and the output terminal OUT and receives the signal from the enable signal input terminal 120s at its gate. The transistor MP124 is connected between the data signal input terminal 120b and the output terminal OUT and receives a signal from the inverter 123. The transistor MN125 is connected between the OFF voltage input terminal 121 and the output terminal OUT and receives the signal from the inverter 123.

When the enable signal supplied to the enable signal input terminal 120s is in “HIGH level”, the transistors MN124 and MP124 constituting a transfer gate are ON, allowing the data signal supplied to the data signal input terminal 120b to be output from the output terminal OUT. When the enable signal supplied to the enable signal input terminal is in “LOW level”, the transistors MN124 and MP124 constituting a transfer gate are OFF while the transistor MN25 is ON, allowing the reference voltage VEE to be output from the output terminal OUT.

Exemplary voltage levels used in a drive device (scanning line driver) are as follows. The system power supply voltage VDD is “1.8 V”, the system ground voltage VSS is “0 V”, the ON voltage VGG required for driving thin film transistors of a liquid crystal display panel is “+15 V”, and the OFF voltage VEE is “−15 V”.

<Internal Construction of Signal Generation Sections>

The signal generation section 106 includes a shift register 116, k level shifters LSa-1 to LSa-k, and k output buffers OBa-1 to OBa-k. The shift register 116 includes k flipflops FFa-1 to FFa-k connected in series. Each of the flipflops FFa-1 to FFa-k receives a start pulse from the frequency divider 104 (or the output from the output terminal Q of the preceding flipflop) at its data terminal D, receives a clock from the frequency divider 105 at its clock terminal CK, and receives a reset signal from the reset signal input terminal 103 at its reset terminal R. Each of the level shifters LSa-1 to LSa-k shifts the output from its corresponding flipflop, which is the signal having an amplitude of VDD−VSS of the logic voltage level, to a signal having an amplitude of VGG-VEE as a voltage required for driving liquid crystal display elements. Each of the output buffers OBa-1 to OBa-k buffers the output from its corresponding level shifter.

The signal generation section 107 includes a shift register 117, m level shifters LSb-1 to LSb-m, and m output buffers OBb-1 to OBb-m. The shift register 117 includes m flipflops FFb-1 to FFb-m connected in series. Each of the flipflops FFb-1 to FFb-m receives a start pulse from the drive signal input terminal 101 (or the output from the output terminal Q of the preceding flipflop) at its data terminal D, receives a clock from the clock input terminal 102 at its clock terminal CK, and receives the reset signal from the reset signal input terminal 103 at its reset terminal R. Each of the level shifters LSb-1 to LSb-m shifts the output from its corresponding flipflop, which is the signal having an amplitude of VDD−VSS of the logic voltage level, to a signal having an amplitude of VGG−VEE as a voltage required for driving a liquid crystal display element. Each of the output buffers OBb-1 to OBb-m buffers the output from its corresponding level shifter.

<Configuration of Each Circuit>

Note that the frequency dividers 104 and 105, the flipflops FFa-1 to FFa-k and the flipflops FFb-1 to FFb-m are composed of low breakdown voltage transistors, while the level shifters LSa-1 to LSa-k, the output buffers OBa-1 to OBa-k, the level shifters LSb-1 to LSb-m, the output buffers OBb-1 to OBb-m and the (k×m) output circuits of the output section 108 are composed of high breakdown voltage transistors.

About 3 V, for example, is enough as the breakdown voltage of low breakdown voltage transistors. About 30 V may sometimes be necessary as the breakdown voltage of high breakdown voltage transistors. In general, the area of a high breakdown voltage transistor is greater than the area of a low breakdown voltage transistor.

<Operation>

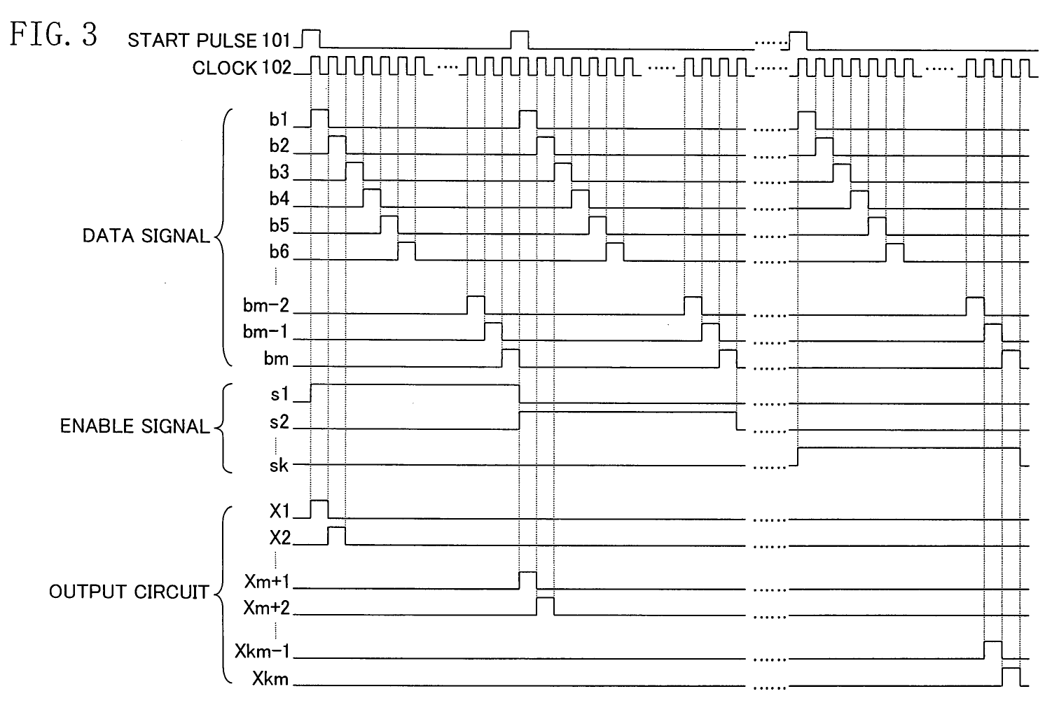

The operation with the drive device shown in FIG. 1 will be described with reference to FIG. 3.

First, when a start pulse is input at the drive signal input terminal 101, the signal generation section 107 sequentially outputs the data signals b1 to bm (sequentially turns the data signals to “HIGH level”) in synchronization with clock pulses input at the clock input terminal 102. Meanwhile, the signal generation section 106 outputs the enable signal s1 in synchronization with a clock frequency-divided by the frequency divider 105. The period of the frequency division by the frequency divider 105 is such that m data signals are sequentially turned to “HIGH level” during the time period when one enable signal is in “HIGH level”. In other words, when the time period from rising of one data signal until rising of the next data signal is defined as “one cycle”, one enable signal is kept in “HIGH level” for “m cycles”. Accordingly, during the time period when the enable signal s1 is in “High level”, the output circuits X1 to Xm belonging to the group Gr1 sequentially output the data signals b1 to bm as drive signals. Note herein that the drive signals have the ON voltage VGG when they are in “HIGH level” and the OFF voltage VEE when they are in “LOW level”.

When the next start pulse is input at the drive signal input terminal 101, the signal generation section 107 again sequentially outputs the data signal b1 to bm. Meanwhile, the signal generation section 106 outputs the next enable signal s2, whereby the output circuits Xm+1 to X2m belonging to the group Gr2 output the data signals b1 to bm as drive signals.

Thereafter, every time a start pulse is input, the data signals b1 to bm are sequentially output, while the next enable signal is put in “HIGH level” for m cycles.

Finally, when the k-th start pulse is input, the output circuits X(k−1)m+1 to Xkm output the data signals b1 to bm as drive signals.

In the manner described above, drive signals are sequentially output from all the (k×m) output circuits.

### SPECIFIC EXAMPLE

Next, the operation with the drive device will be described specifically, assuming that m=16 and k=20.

When the first start pulse is input, the data signals b1 to b16 are sequentially output. Meanwhile, the enable signal s1 is put in “HIGH level” for 16 cycles, while the other enable signals s2 to s20 are kept in “LOW level”. Accordingly, the output circuits X1 to X16 sequentially output drive signals, while the output circuits X17 to X320 do not output drive signals although receiving the data signals because their corresponding enable signals are not input.

Subsequently, when the second start pulse is input, the data signals b1 to b16 are again sequentially output. Meanwhile, the enable signal s2 is put in “HIGH level” for 16 cycles, while the other enable signals s1 and s3 to s20 are kept in “LOW level”. Accordingly, the output circuits X17 to X32 sequentially output drive signals, while the output circuits X1 to X16 and X33 to X320 do not output drive signals although receiving the data signals because their corresponding enable signals are not input.

Finally, when the 20th start pulse is input, the data signals b1 to b16 are sequentially output, and the enable signal s20 is put in “HIGH level” for 16 cycles. Accordingly, the output circuits X305 to X320 sequentially output drive signals, while the output circuits X1 to X304 do not output drive signals although receiving the data signals because their corresponding enable signals are not input. Thus, drive signals are sequentially output from the 320 output circuits X1 to X320 during the time period of 320 cycles.

<Effect>

As described above, by combining the signal generation section having k outputs and the signal generation section having m outputs, a total of (k×m) drive signals are output. That is, the number of outputs in the upstream part of the drive device can be reduced, and thus the circuit scale of the drive device can be reduced.

Hereinafter, the effect of reducing the area of the drive device attained in this embodiment will be described by way of example. For comparison with a conventional case under the same standard, the case that the number of outputs is “320” will be described. Also, for comparison with a conventional case under the same standard, data designed using semiconductor processes having the same transistor minimum line widths (gate lengths) are compared.

The estimated circuit areas obtained by adopting this embodiment were as follows.

Output circuit: 19500 μm²

Output buffer: 18900 μm²

Level shifter: 28700 μm²

Flipflop: 9100 μm²

Frequency divider: 10000 μm²

Assuming that m=16 and k=20, the area (S106) of the signal generation circuit 106, the area (S107) of the signal generation section 107 and the area (S108) of the output section 108 were as follows.

S106=(28700+18900+9100)×16=0.91 mm²

S107=(28700+18900+9100)×20=1.13 mm²

S1108=19500×320=6.24 mm²

The area (Sα) of the remaining part of the device was “0.10 mm²”.

The total area (SSS) in this embodiment was then as follows.

SSS=S106+S107+S108+Sα=8.3 mm²

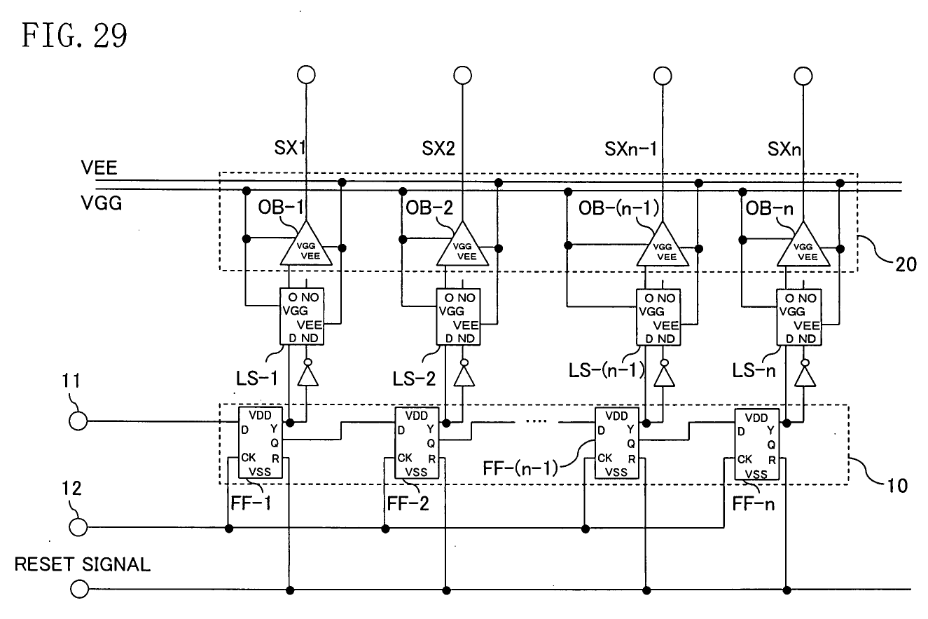

On the contrary, the estimated circuit areas in the conventional drive device shown in FIG. 29 were as follows.

Output buffer: 14000 μm²

Level shifter: 28700 μm²

Flipflop: 9100 μm²

The total area (SSS′) in the conventional case was then as follows.

SSS′=(14000+28700+9100)×320=16.58 mm²

In comparison between the above cases, it is found that the total area (SSS) in this embodiment is as small as about 50% of the total area (SSS) in the conventional case.

### SECOND EMBODIMENT

### Configuration

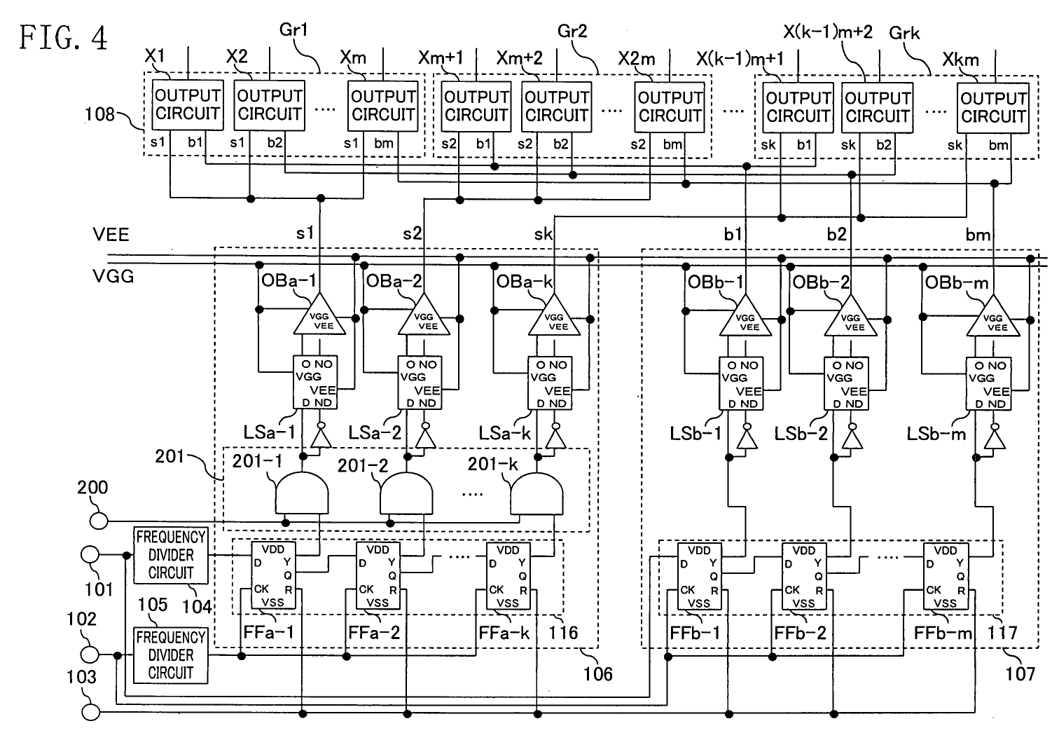

FIG. 4 shows the entire configuration of a drive device of the second embodiment of the present invention. This drive device includes a control signal input terminal 200 and a logic circuit 201 in addition to the components of the drive device shown in FIG. 1. The control signal input terminal 200 receives an external control signal. The logic circuit 201 turns all the outputs from the shift register 116 to “LOW level” according to the control signal input at the control signal input terminal 200. The other configuration is substantially the same as that in FIG. 1.

The logic circuit 201 includes k AND circuits 201-1 to 201-k. Each of the AND circuits 201-1 to 201-k receives the control signal input at the control signal input terminal 200 and the output from its corresponding flipflop. For example, the AND circuit 200-1 receives the control signal and the output from the flipflop FFa-1.

<Operation>

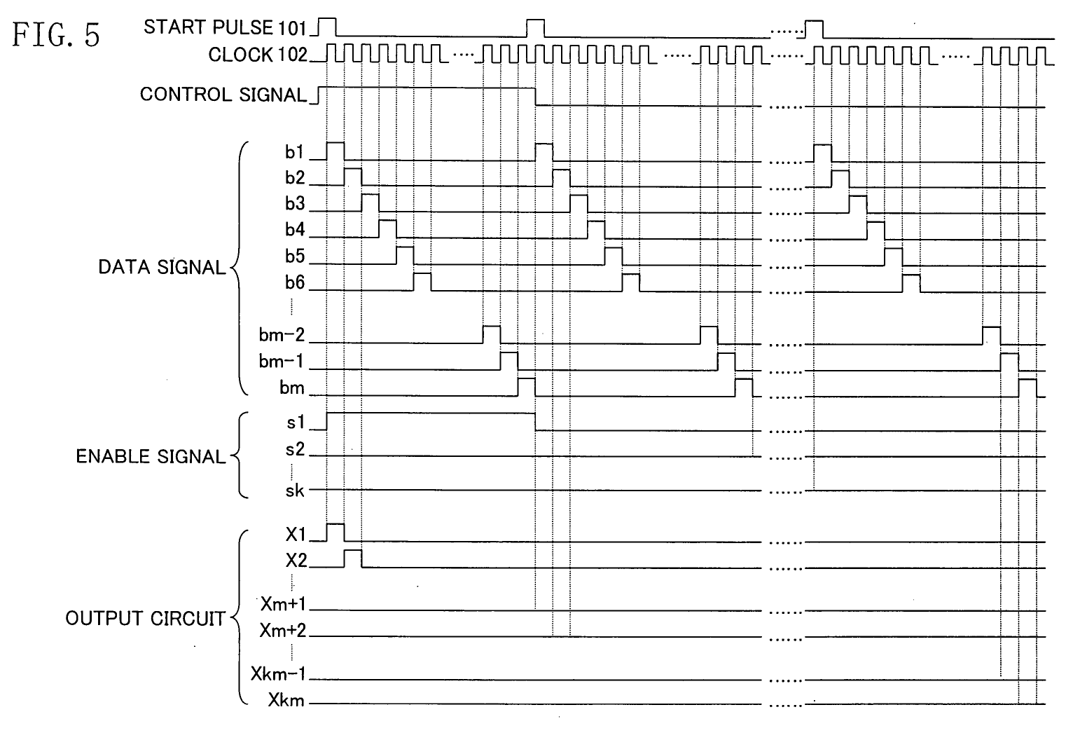

The operation with the drive device shown in FIG. 4 will be described with reference to FIG. 5.

When the control signal is being input at the control signal input terminal 200 (when the control signal is in “HIGH level”), each of the outputs from the shift register 116 is supplied to the corresponding level shifter without being blocked by the logic circuit 201. That is, substantially the same operation as that in FIG. 3 is executed.

On the contrary, when the control signal is not being input at the control signal input terminal 200 (when the control signal is in “LOW level”), all the outputs from the k AND circuits 201-1 to 201-k are turned to “LOW level”, and thus the outputs from the level shifters LSa-1 to LSa-k are also turned to “LOW level”. For example, the enable signal s2 is not output even if the output from the flipflop FFa-2 of the shift register 116 is in “HIGH level”. In this case, since the enable signal s2 is not supplied to any of the output circuits Xm+1 to X2m, no drive signal is output from the output circuits Xm+1 to X2m (no drive signal is turned to “HIGH level”) even if the data signal b1 to bm are sequentially supplied to the output circuits Xm+1 to X2m.

Thus, while drive signals are output during the time when the control signal is being input, no drive signal is output during the time when the control signal is not being input.

<Effect>

As described above, the output of drive signals can be restricted with the control signal. This permits display of only a predetermined line (or updating of the image displayed on the predetermined line) in a liquid crystal display panel. In other words, a partial display function can be attained. Moreover, since the level shifters and the output buffers stop their operations during the time of non-input of the control signal, power consumption can be reduced.

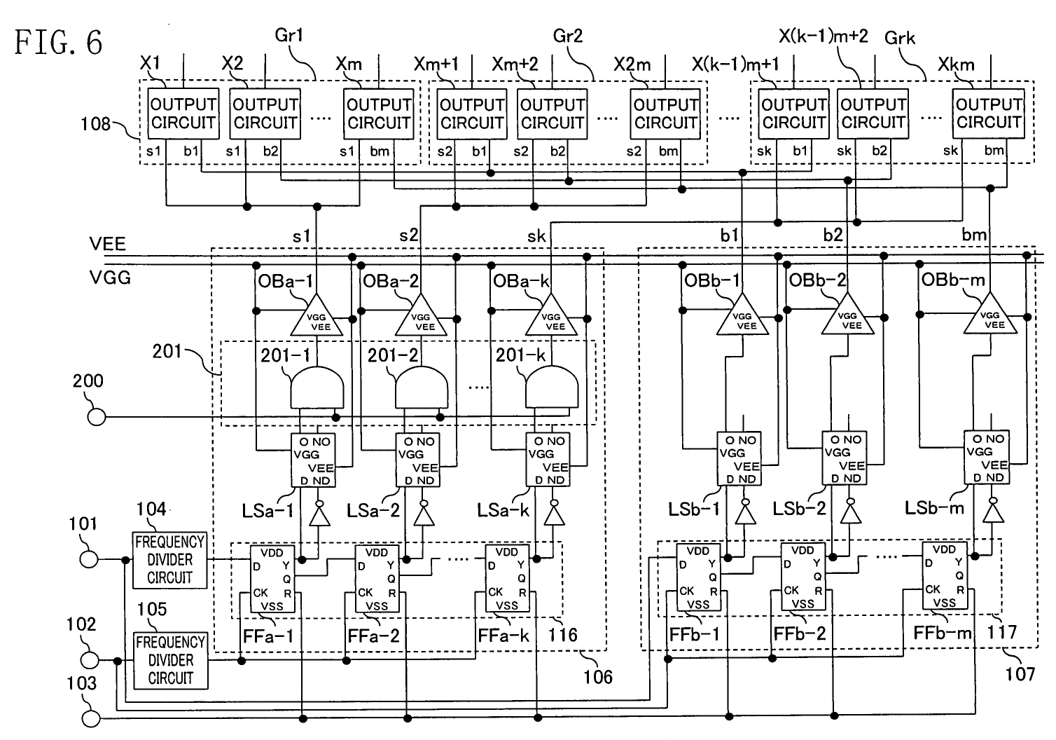

Note that substantially the same effect can also be obtained by placing the logic circuit 201 between the level shifters LSa-1 to LSa-k and the output buffers OBa-1 to OBa-k as shown in FIG. 6. In this case, the logic circuit 201 is composed of high breakdown voltage transistors.

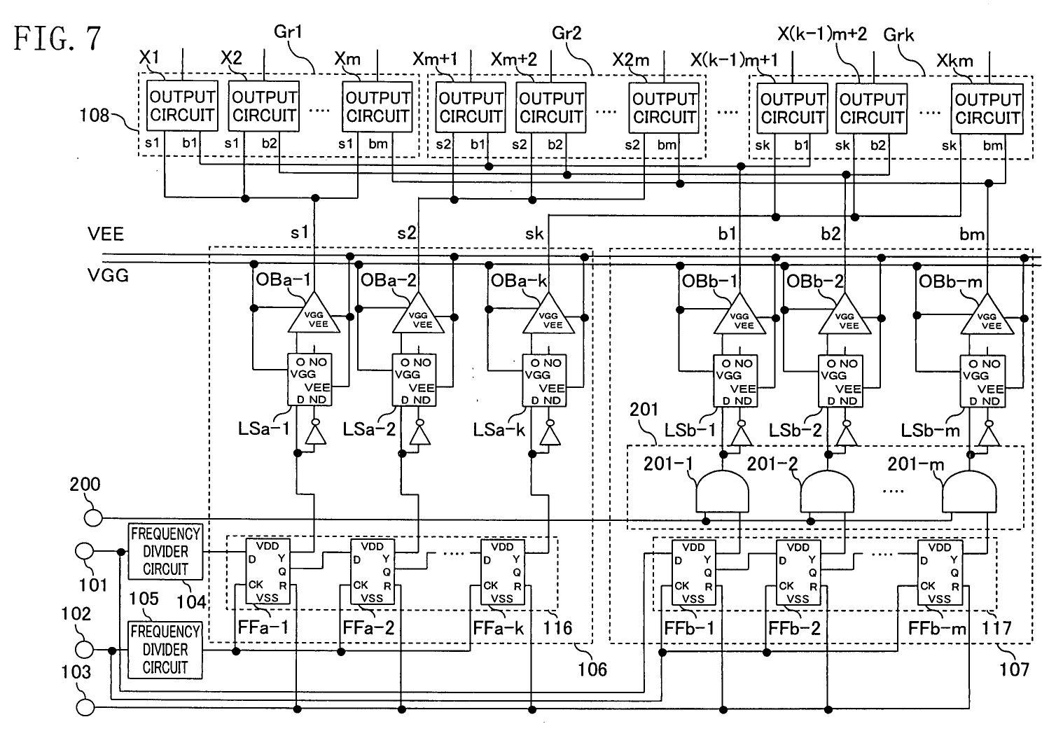

Alternatively, substantially the same effect can also be obtained by placing the logic circuit 201 between the shift register 117 and the level shifters LSb-1 to LSb-m of the signal generation section 107 as shown in FIG. 7. In this case, the logic circuit 201 includes m AND circuits 201-1 to 201-m.

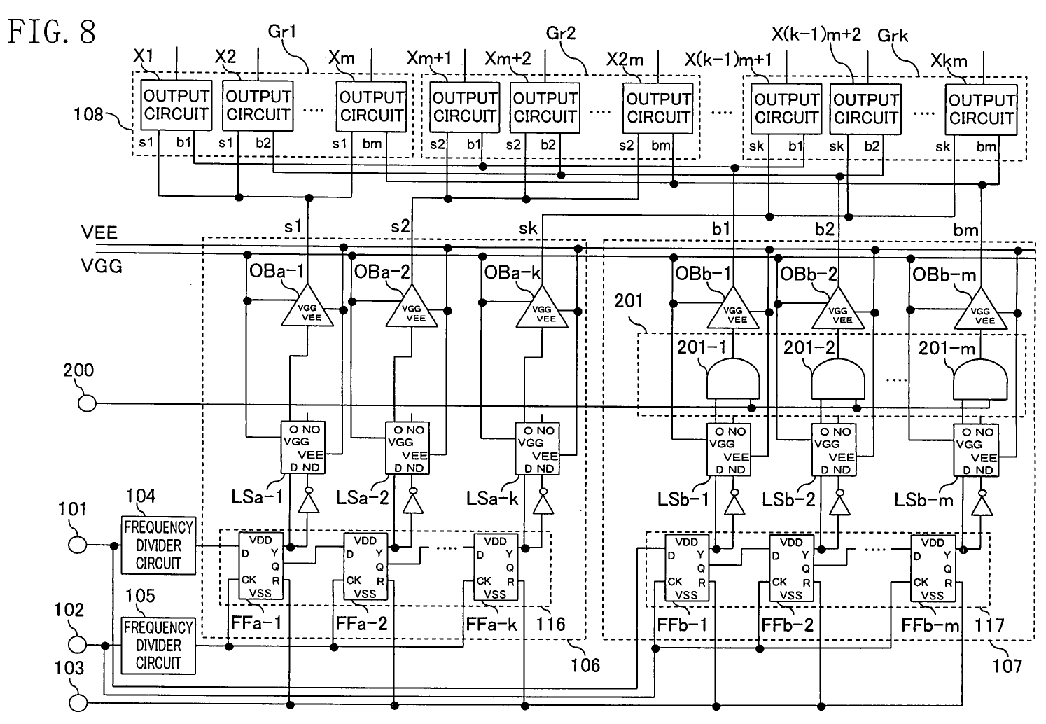

Alternatively, substantially the same effect can also be obtained by placing the logic circuit 201 between the level shifters LSb-1 to LSb-m and the output buffers OBb-1 to OBb-m as shown in FIG. 8. In this case, the logic circuit 201 is composed of high breakdown voltage transistors.

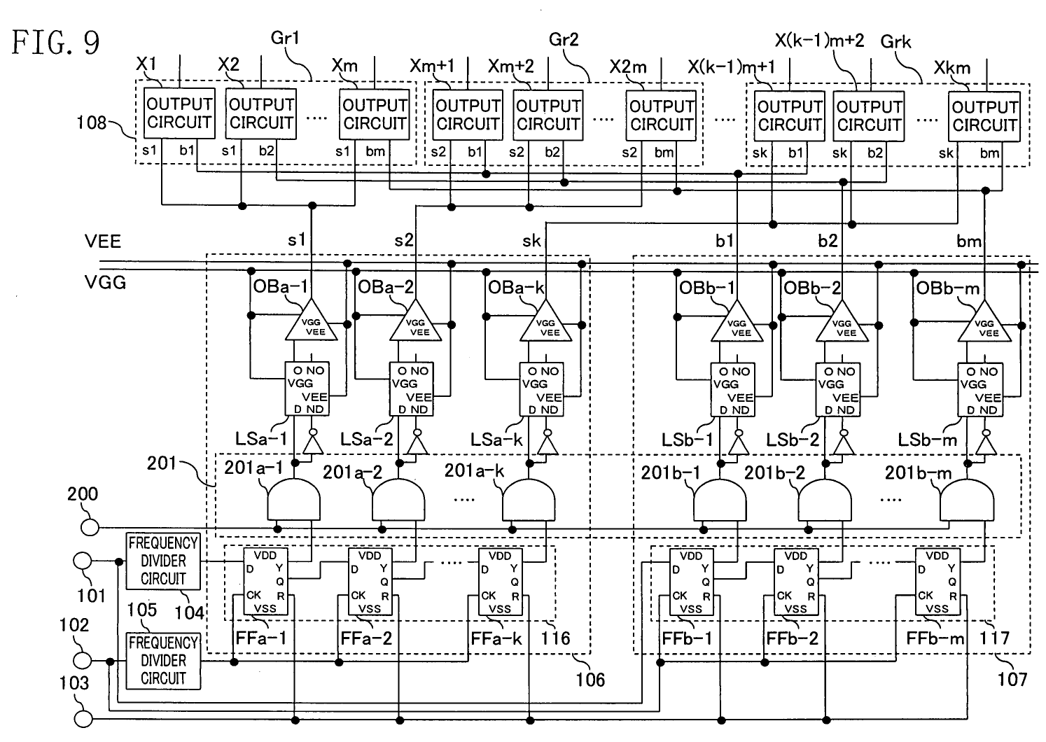

Alternatively, substantially the same effect can also be obtained by placing the logic circuit 201 between the shift register 116 and the level shifters LSa-1 to LSa-k and between the shift register 117 and the level shifters LSb-1 to LSb-m as shown in FIG. 9. In this case, the logic circuit 201 includes AND circuits 201a-1 to 201a-k and 201b-1 to 201b-m. Also, since not only the level shifters and the output buffers in one signal generation section but also those in the other signal generation section stop their operations during the time of non-input of the control signal, power consumption can further be reduced.

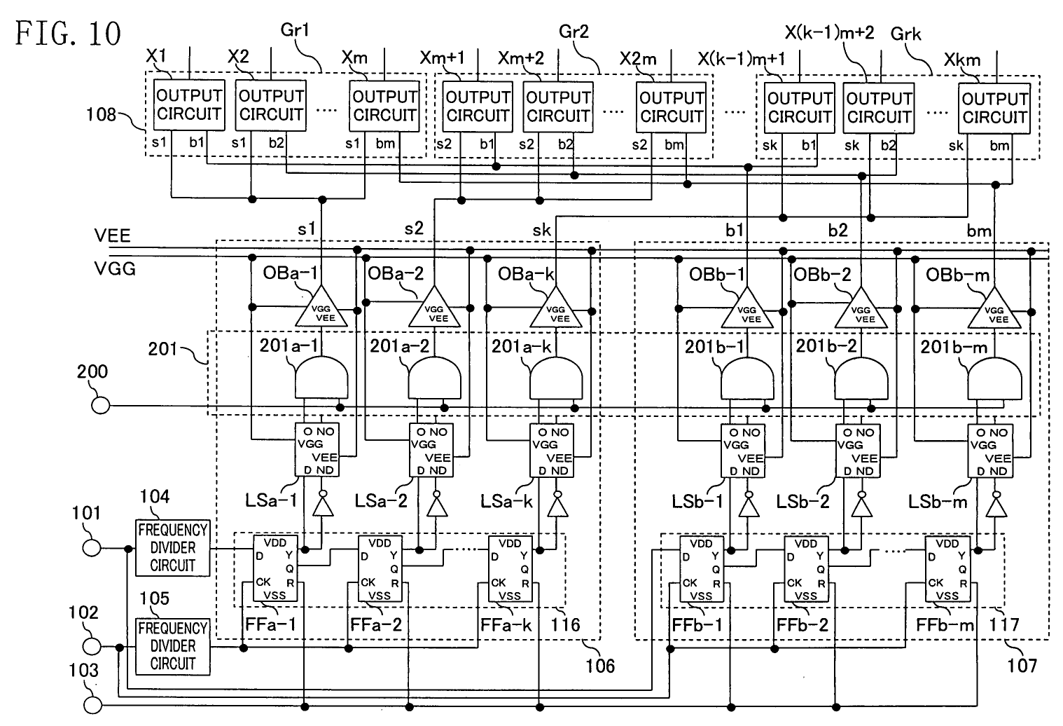

Alternatively, substantially the same effect can also be obtained by placing the logic circuit 201 between the level shifters LSa-1 to LSa-k and the output buffers OBa-1 to OBa-k and between the level shifters LSb-1 to LSb-m and the output buffers OBb-1 to OBb-m as shown in FIG. 10. In this case, the logic circuit 201 is composed of high breakdown voltage transistors.

### THIRD EMBODIMENT

### Configuration

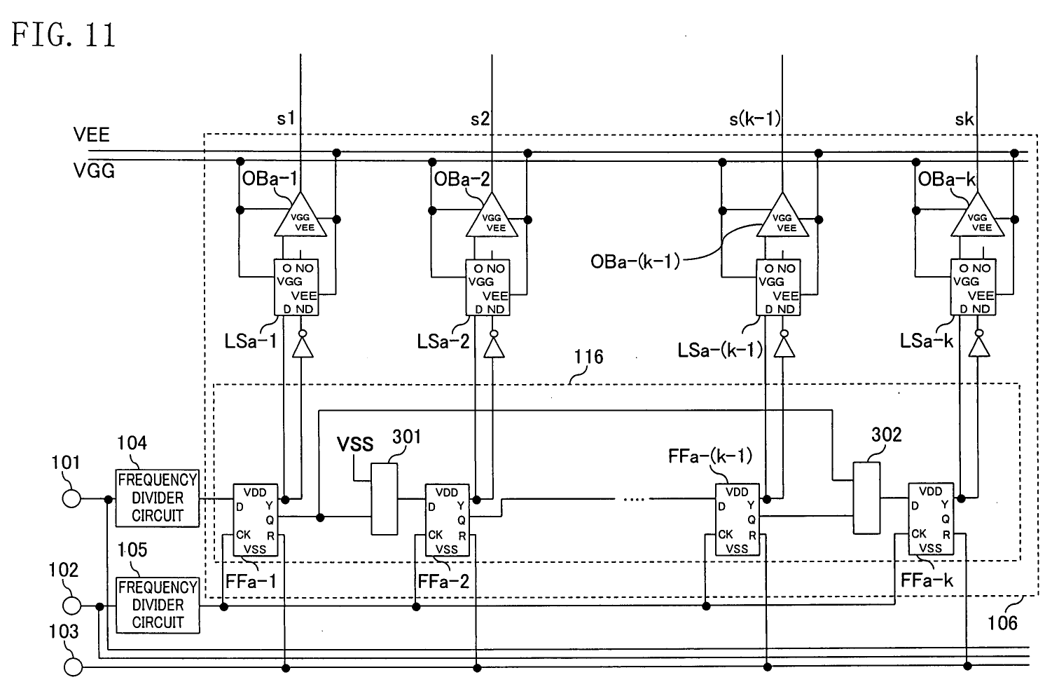

The entire configuration of a drive device of the third embodiment of the present invention is the same as that in FIG. 1, except for the internal configuration of the signal generation section 106. FIG. 11 shows the internal configuration of the signal generation section 106 in this embodiment. The signal generation section 106 includes selectors 301 and 302 in addition to the components of the signal generation section shown in FIG. 1. The other configuration is substantially the same as that in FIG. 1.

The selector 301 is connected between the flipflops FFa-1 and FFa-2, and has a normal mode and a partial display mode. In the normal mode, the selector 301 supplies the output from the preceding flipflop FFa-1 to the following flipflop FFa-2. In the partial display mode, the selector 301 supplies the system ground voltage VSS to the flip-flop FFa-2.

The selector 302 is connected between the flipflops FFa-(k−1) and FFa-k, and has the normal mode and the partial display mode. In the normal mode, the selector 302 supplies the output from the preceding flipflop FFa-(k−1) to the following flipflop FFa-k. In the partial display mode, the selector 302 supplies the output from the flipflop FFa-1 (flipflop preceding the selector 301) to the following flipflop FFa-k.

<Operation>

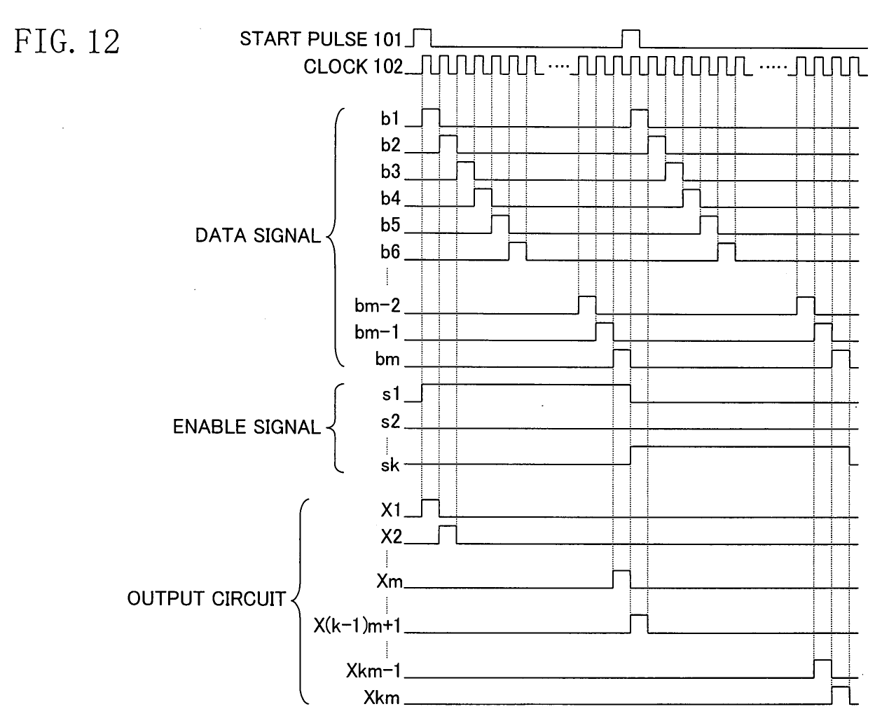

The operation with the drive device shown in FIG. 11 will be described with reference to FIG. 12.

In the normal mode, like the operation shown in FIG. 3, one enable signal is turned to “HIGH level” with one start pulse, while the data signals b1 to bm are sequentially output.

In the partial display mode, following the enable signal s1, not the enable signal s2, but the enable signal sk is turned to “HIGH level”. Therefore, drive signals are sequentially output, not from the output circuits Xm+1 to X2m, but from the output circuits X(k−1)m+1 to Xkm.

<Effect>

As described above, by changing the operation mode of the selectors, the output of the drive signals can be restricted. This makes it possible not to display only a predetermined line (or not to update the image displayed on the predetermined line) in a liquid crystal display panel. In other words, a partial display function can be attained. Moreover, since the flipflops FFa-2 to FFa-(k−1) stop their operations in the partial display mode, power consumption can be reduced.

For example, if it is intended not to display the segment from the 10th line through the 20th line in a liquid crystal display panel having (k×m) lines in the partial display mode, the selector 301 should be connected between the 9th flipflop FFa-9 and the 10th flipflop FFa-10, and the selector 302 should be connected between the 20th flipflop FFa-20 and the 21st flipflop FFa-21.

### FOURTH EMBODIMENT

### Configuration

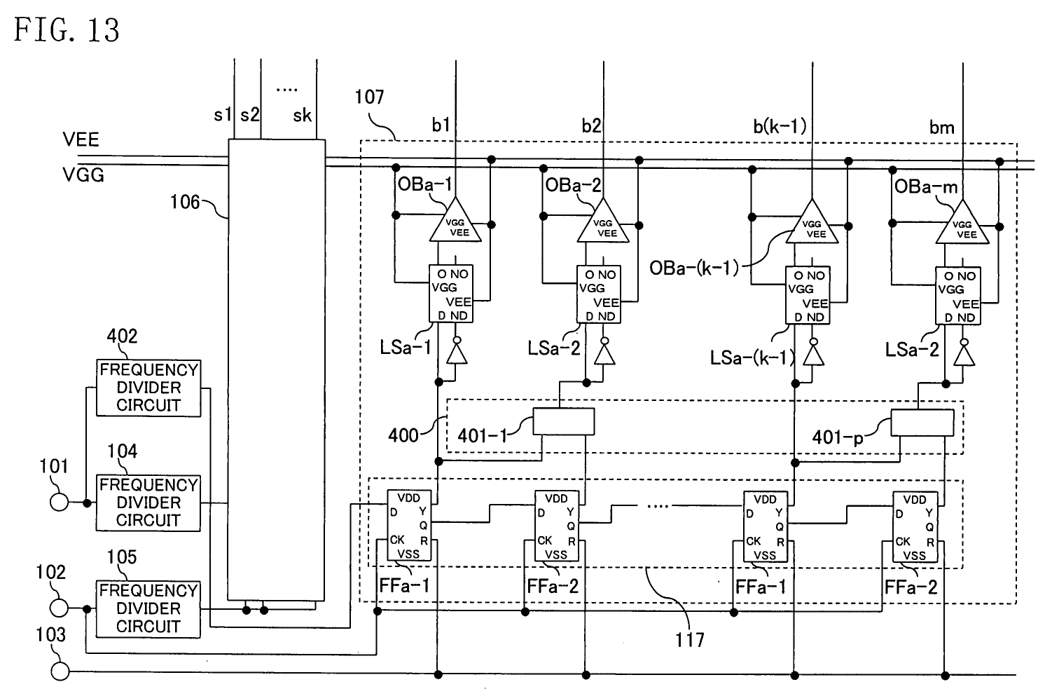

FIG. 13 shows the entire configuration of a drive device of the fourth embodiment of the present invention. This device includes a selection circuit 400 and a frequency divider 402 in addition to the components of the drive device shown in FIG. 1. The selection circuit 400 includes p selectors 401-1 to 401-p (p is “k/2” where k is an even number). The other configuration is substantially the same as that in FIG. 1.

Each of the selectors 401-1 to 401-p corresponds to two flipflops and two level shifters. For example, the selector 401-1 corresponds to two flipflops FFb-1 and FFb-2 and two level shifters LSb-1 and LSb-2.

Each of the selectors 401-1 to 401-p has a normal mode and a 2-line drive mode. In the normal mode, each of the selectors 401-1 to 401-p supplies the output from its corresponding first flipflop to its corresponding first level shifter, and supplies the output from its corresponding second flipflop to its corresponding second level shifter. For example, the selector 401-1 supplies the output from the flipflop FFb-1 to the level shifter LSb-1, and supplies the output from the flipflop FFb-2 to the level shifter LSb-2. In the 2-line mode, each of the selectors 401-1 to 401-p supplies the output from the first flip-flop to the first and second level shifters. For example, the selector 401-1 supplies the output from the flipflop FFb-1 to the level shifters LSb-1 and LSb-2.

The frequency divider 402 has the normal mode and the 2-line drive mode. In the normal mode, the frequency divider 402 outputs the start pulse input at the drive signal input terminal 101 as it is. In the 2-line drive mode, the frequency divider 402 frequency-divides the start pulse input at the drive signal input terminal 101 by predetermined cycles. The shift register 117 receives the start pulse from the frequency divider 402.

<Operation>

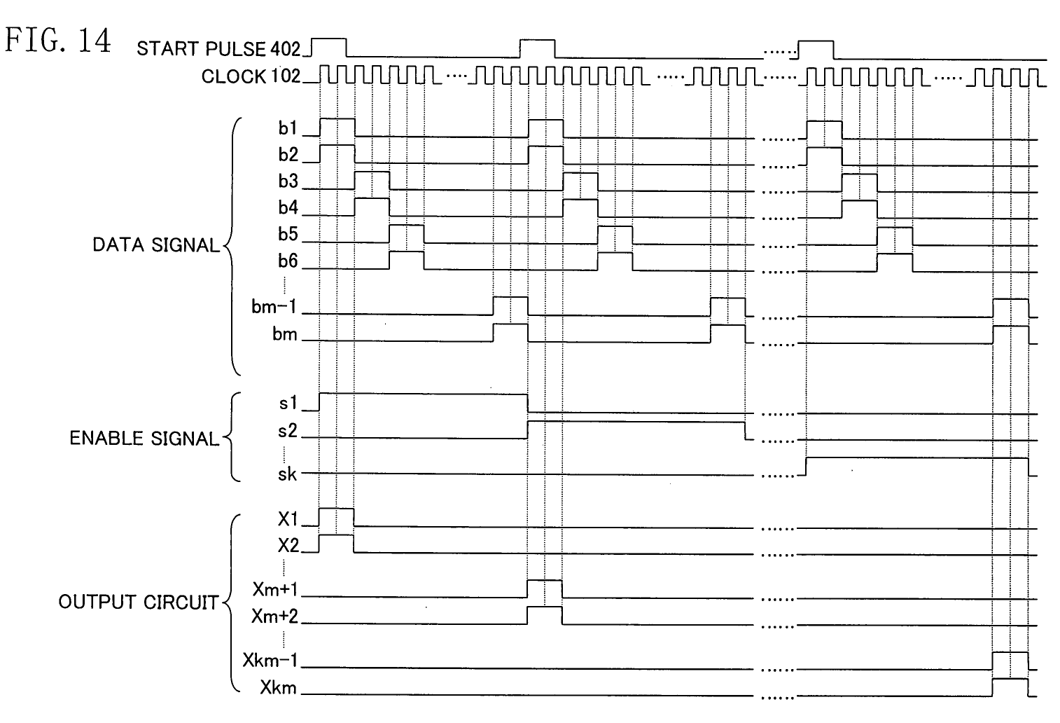

The operation with the drive device shown in FIG. 13 will be described with reference to FIG. 14.

In the normal mode, the frequency divider 402 outputs the start pulse input at the drive signal input terminal 101 as it is. The selector 401-1 supplies the output from the flipflop FFb-1 to the level shifter LSb-1, and supplies the output from the flipflop FFb-2 to the level shifter LSb-2. Thus, substantially the same operation as that shown in FIG. 3 is executed.

In the 2-line drive mode, the shift register 117 receives a start pulse frequency-divided by the frequency divider 402 (start pulse having an extended “HIGH level” time period). The output from the flipflop FFb-1 is supplied to the level shifters LSb-1 and LSb-2 via the selector 401-1, and thus the data signals b1 and b2 are output simultaneously. In this way, the output circuits X1 and X2 output their drive signals simultaneously.

<Effect>

As described above, a plurality of drive signals can be output simultaneously according to the operation mode of the selectors. Specifically, a plurality of lines (two lines in this embodiment) can be made active simultaneously in a liquid crystal display panel. This can lower the resolution of the liquid crystal display panel. Also, since the number of times of write with a data driver (not shown) of the liquid crystal display panel can be reduced, power consumption can be reduced.

Although 2-line drive was described in this embodiment, N-line drive (N is a natural number) is also possible. In this case, it is only necessary to make one selector correspond to N flipflops and N level shifters. In the normal mode, each selector only needs to give one-to-one correspondence for the N flipflops and the N level shifters. In the N-line drive mode, each selector only needs to supply the output from the first flip-flop among the corresponding flipflops to all the N level shifters.

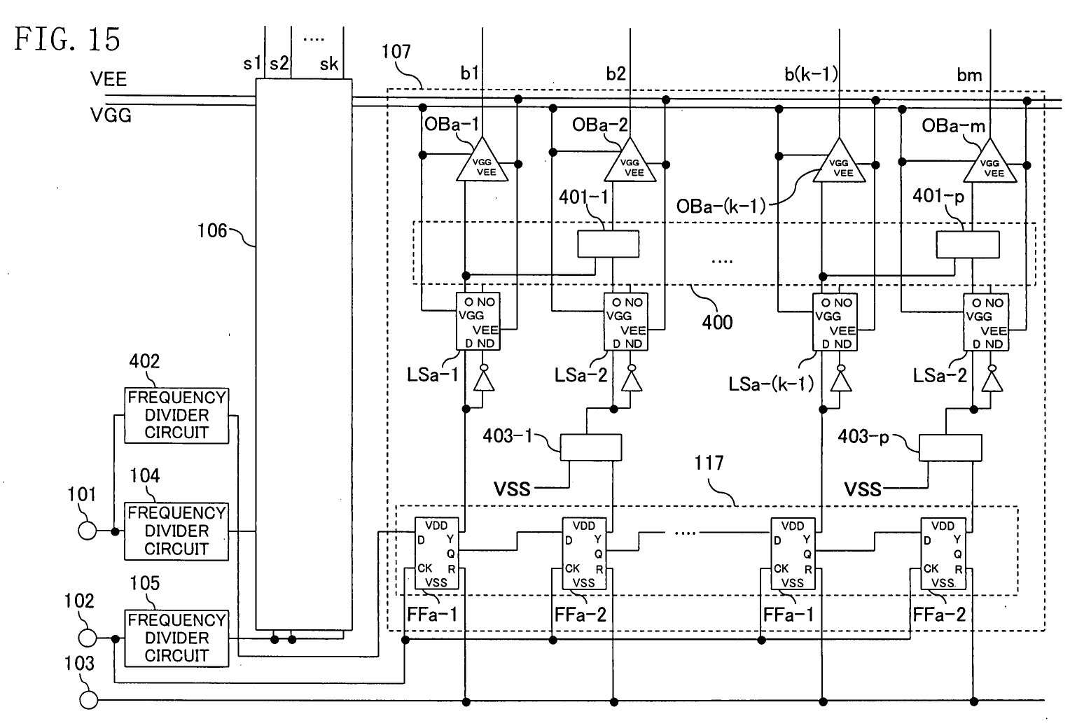

Note that substantially the same effect can also be obtained by connecting the selectors 401-1 to 401-p between the level shifters LSb-1 to LSb-m and the output buffers OBb-1 to OBb-m as described in FIG. 15. In this case, each of the selectors 401-1 to 401-p corresponds to two level shifters and two output buffers. In this case, also, it is possible to additionally provide p selectors 403-1 to 403-p between the flipflops FFb-1 to FFb-m and the level shifters LSb-1 to LSb-m. Each of the selectors 403-1 to 403-p is given for an even-numbered flipflop and an even-numbered level shifter. In the normal mode, each of the selectors 403-1 to 403-p supplies the output from its corresponding flipflop to its corresponding level shifter. For example, the selector 403-1 supplies the output from the flipflop FFb-2 to the level shifter LSb-2. In the 2-line drive mode, each of the selectors 403-1 to 403-p supplies the system ground voltage VSS to its corresponding level shifter. This can save power consumption by the level shifter that is unnecessary in the 2-line drive mode.

### FIFTH EMBODIMENT

### Configuration

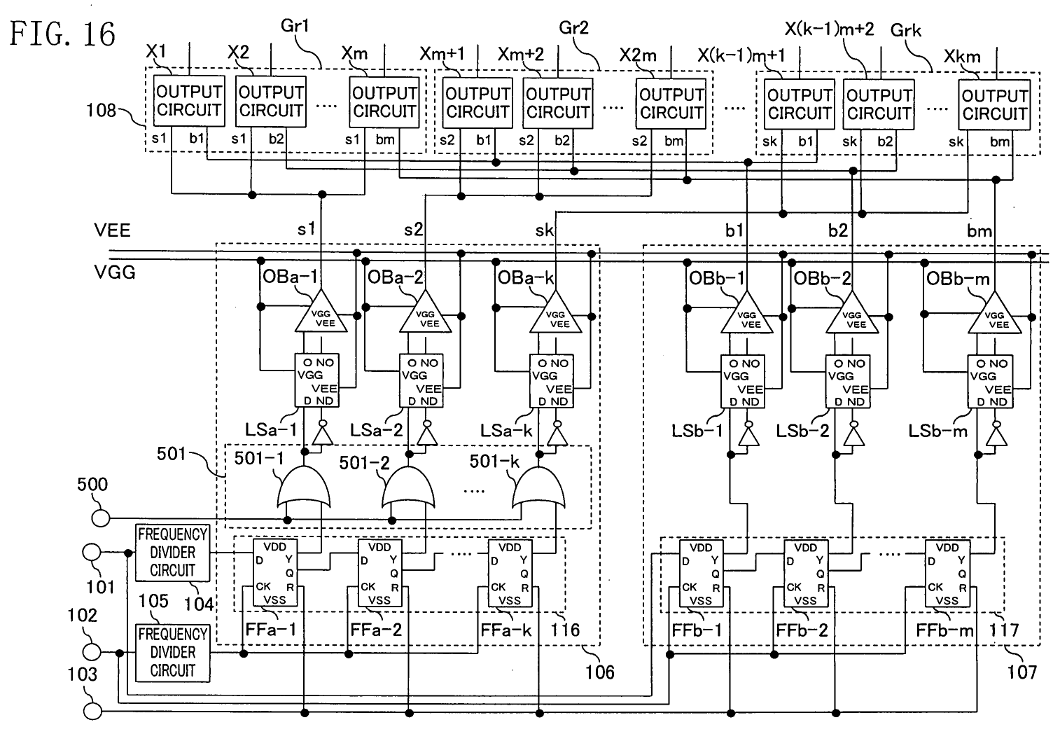

FIG. 16 shows the entire configuration of a drive device of the fifth embodiment of the present invention. This device includes a control signal input terminal 500 and a logic circuit 501 in addition to the components of the drive device shown in FIG. 1. The control signal input terminal 500 receives an external control signal. The logic circuit 501 turns all of the k outputs from the shift register 116 to “HIGH level” when the control signal input at the control signal input terminal 500 is in “HIGH level”. The other configuration is substantially the same as that in FIG. 1.

The logic circuit 501 includes k OR circuits 501-1 to 501-k. Each of the OR circuits 501-1 to 501-k receives the control signal input at the control signal input terminal 500 and the output from its corresponding flipflop. For example, the OR circuit 501-1 receives the control signal and the output from the flipflop FFa-1.

<Operation>

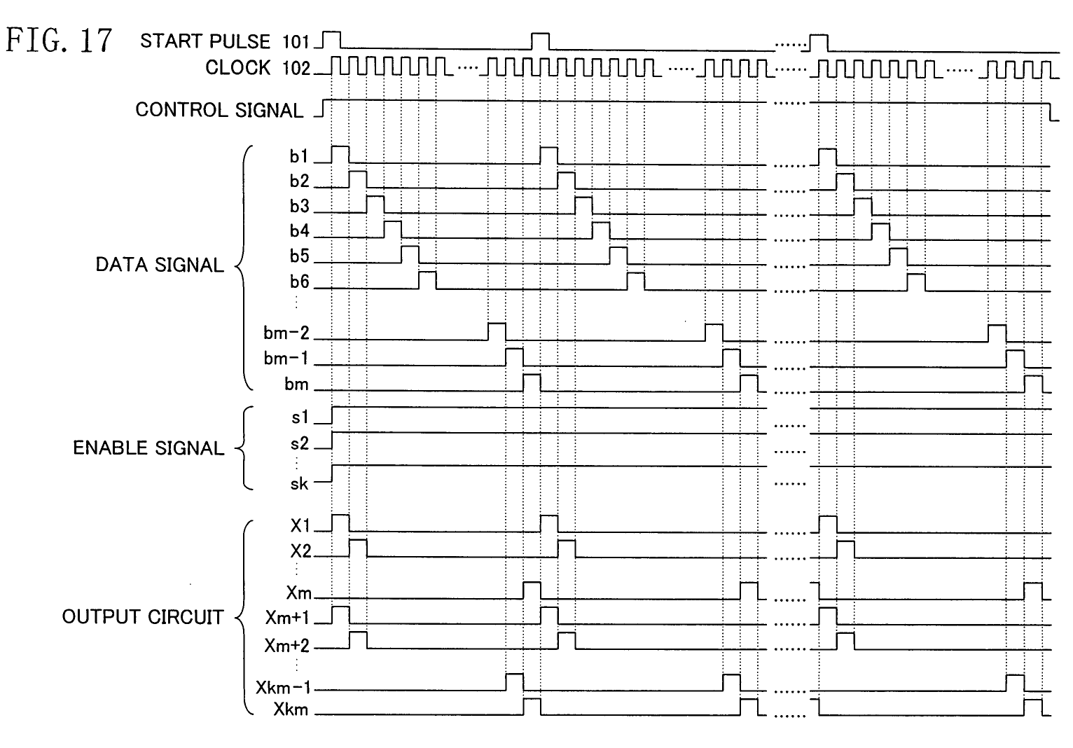

The operation of the drive device shown in FIG. 16 will be described with reference to FIG. 17.

when the control signal is not being input at the control signal input terminal 500 (when the control signal is in “LOW level”), each of the enable signals s1 to sk from the shift register 116 is supplied to the corresponding level shifter. That is, substantially the same operation as that shown in FIG. 3 is executed.

When the control signal is being input at the control signal input terminal 500 (when the control signal is in “HIGH level”), all the outputs from the k OR circuits 501-1 to 501-k are turned to “HIGH level”. In other words, the enable signals s1 to sk are supplied to the respective m output circuits simultaneously. For example, even when the output from the flipflop FFa-1 of the shift register 116 is in “HIGH level” and the outputs from the other flipflops FFa-2 to FFa-k are in “LOW level”, not only the enable signal s1 but also the enable signals s2 to sk are output. Thus, once the data signal b1 is output, not only the output circuit X1 but also the output circuits Xm+1, . . . , X(k−1)m+1 output drive signals simultaneously. That is, not only the m output circuits belonging to the group Gr1 but also the output circuits belonging to the other groups Gr2 to Grk sequentially output drive signals simultaneously.

As described above, during the time when the control signal is being input, drive signals are output not only from the output circuits belonging to one group but also from the output circuits belonging to the other groups simultaneously.

<Effect>

As described above, during the time period of the control signal being in “HIGH level”, a plurality of drive signals can be output simultaneously. Also, in the 2-line drive mode, the frequency divider 104 may be set so as to output the clock input at the drive signal input terminal 101 as it is without frequency-dividing the clock. This can shorten the time of image write with a data driver (not shown) when a solid image (image uniform in gray scale level over the entire image (for example, an image in which all pixels are “white”)) is displayed.

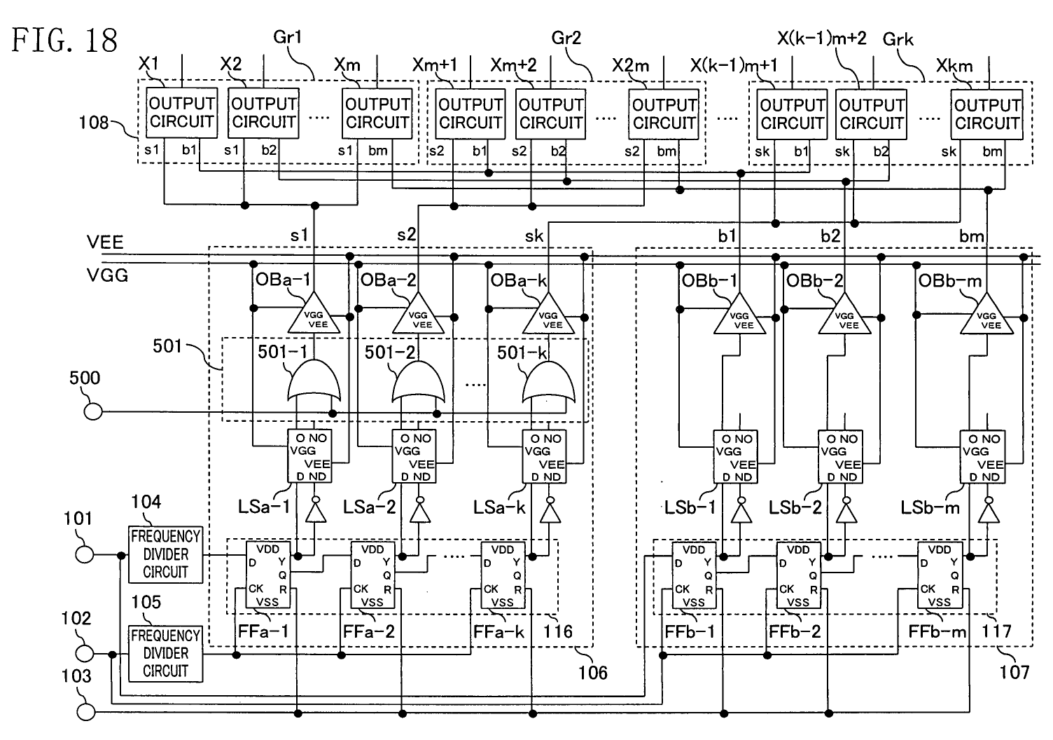

Note that substantially the same effect can also be obtained by connecting the logic circuit 501 between the level shifters LSa-1 to LSa-k and the output buffers OBa-1 to OBa-k as shown in FIG. 18. In this case, the logic circuit 501 is composed of high breakdown voltage transistors.

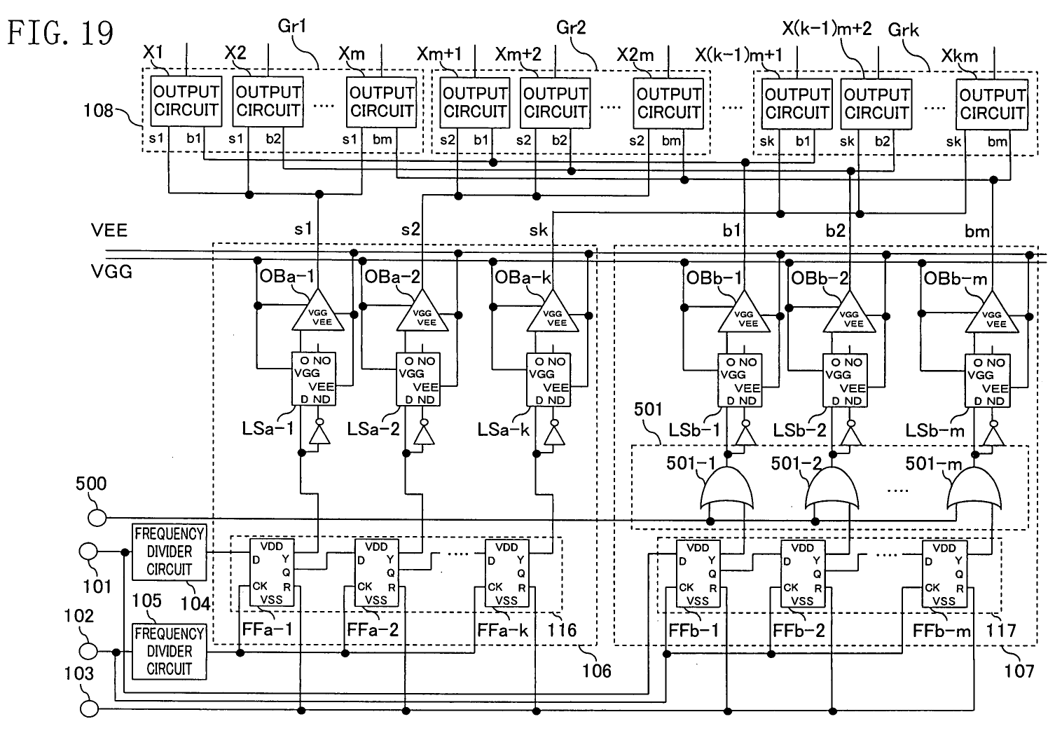

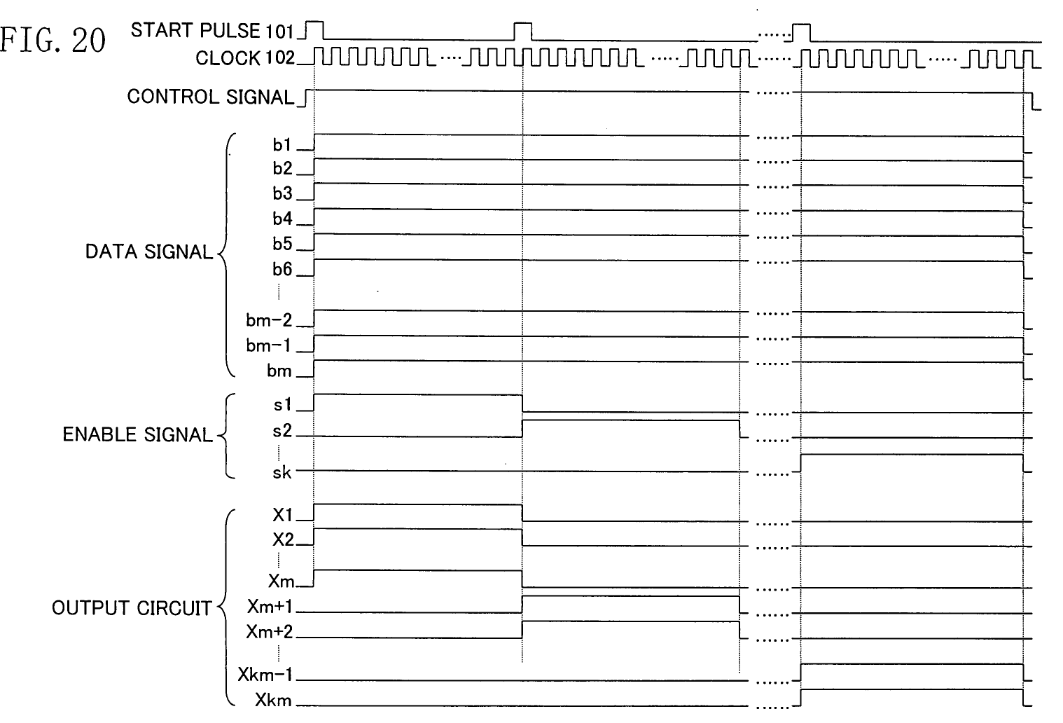

Alternatively, substantially the same effect can be obtained by connecting the logic circuit 501 between the shift register 117 and the level shifters LSb-1 to LSb-m of the signal generation section 107 as shown in FIG. 19. In this case, the logic circuit 501 includes m OR circuits 501-1 to 501-m. In this case, also, as shown in FIG. 20, when the control signal is being input at the control signal input terminal 500 (when the control signal is in “HIGH level”), all of the data signals b1 to bm are turned to “HIGH level” simultaneously. Thus, all of the output circuits that receive a “HIGH level” enable signal output their drive signals simultaneously. For example, when the enable signal s1 is in “HIGH level”, all of the output circuits X1 to Xm output drive signals simultaneously.

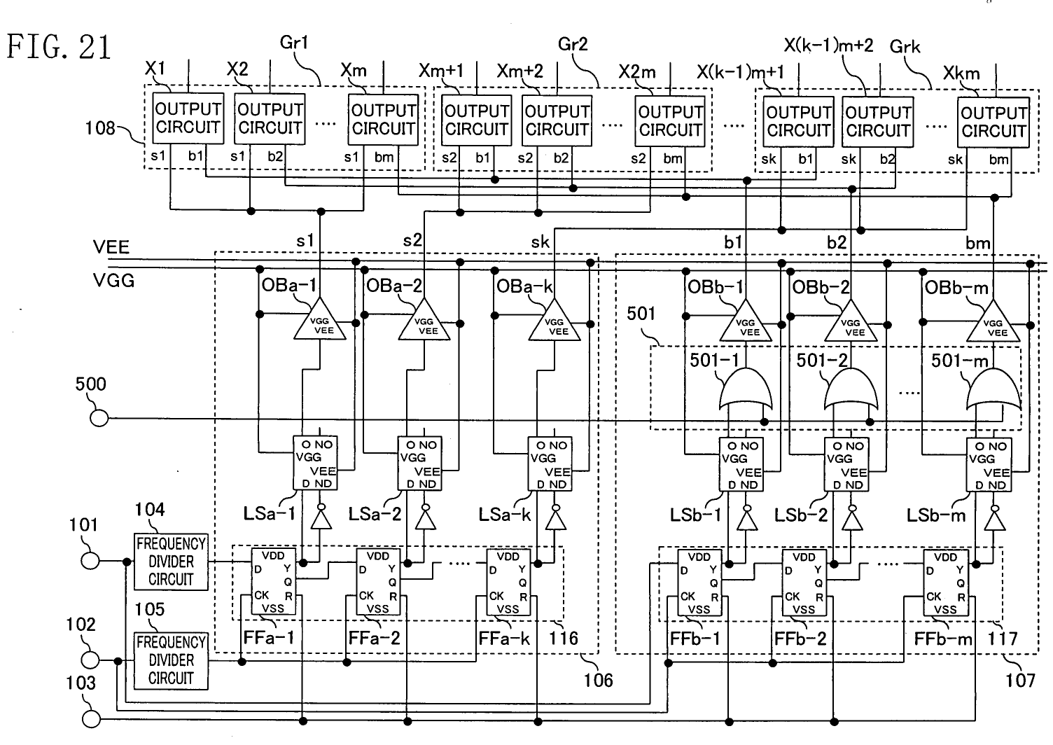

Alternatively, substantially the same effect can be obtained by connecting the logic circuit 501 between the level shifters LSb-1 to LSb-m and the output buffers OBb-1 to OBb-m as shown in FIG. 21. In this case, the logic circuit 501 is composed of high breakdown voltage transistors.

### SIXTH EMBODIMENT

### Configuration

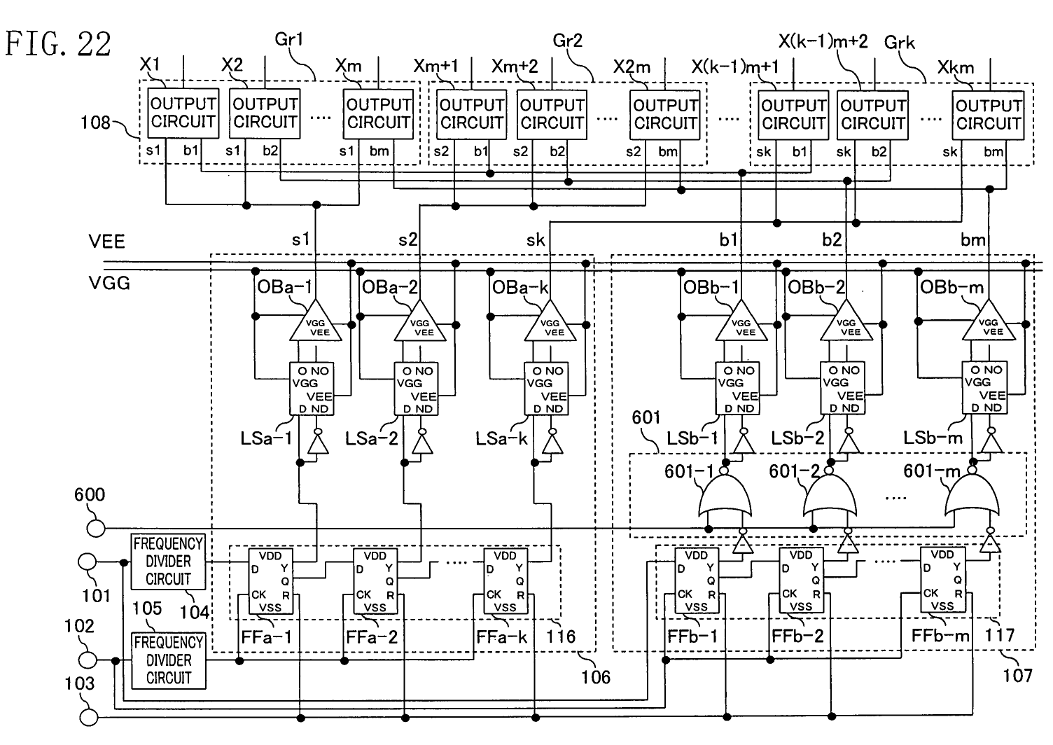

FIG. 22 shows the entire configuration of a drive device of the sixth embodiment of the present invention. This device includes a control signal input terminal 600 and a logic circuit 601. The control signal input terminal 600 receives an external control signal. The logic circuit 601 turns all of the data signals b1 to bm from the shift register 117 to “LOW level” when the control signal input at the control signal input terminal 600 is in “HIGH level”.

The logic circuit 601 includes m NOR circuits 601-1 to 601-m. Each of the NOR circuits 601-1 to 601-m receives the control signal input at the control signal input terminal 600 and an inverted signal of the output from its corresponding flipflop. For example, the NOR circuit 601-1 receives the control signal and an inverted signal of the output from the flipflop FFb-1. The other configuration is substantially the same as that in FIG. 1.

<Operation>

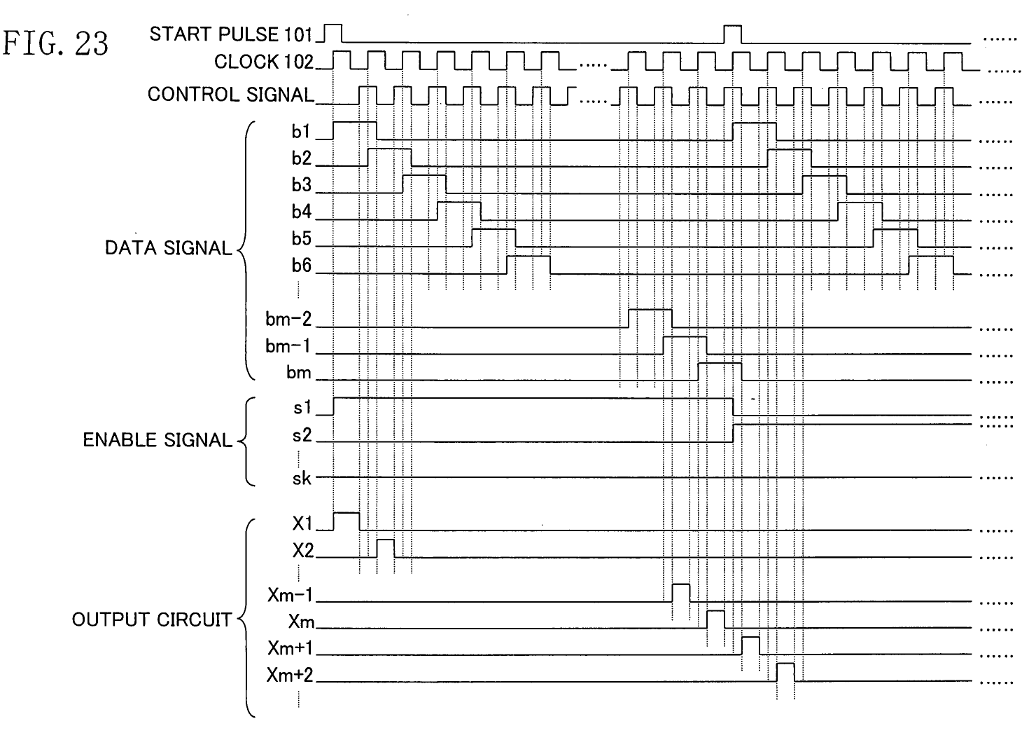

The operation of the drive device shown in FIG. 22 will be described with reference to FIG. 23. Note herein that since each of the output buffers OBb-1 to OBb-m is composed of high breakdown voltage transistors, each of the m outputs from the output buffers OBb-1 to OBb-m is large in rising time and falling time and the waveform thereof is deformed. Also, for the purpose of explanation, the waveforms of the data signals b1 to bm shown in FIG. 23 are those that would have been obtained if the outputs from the shift register 117 are supplied directly to the level shifters LSb-1 to LSb-m.

First, a signal is output from the flipflop FFb-1. Since the control signal is in “LOW level” at this time, the data signal b1 is turned to “HIGH level”. Thus, the drive signal from the output circuit X1 is turned to “HIGH level”.

The control signal is then turned to “HIGH level”. This turns the signal from the flipflop FFb-1 to “LOW level”, and hence turns the data signal b1 to “LOW level”. Thus, the drive signal from the output circuit X1 is turned to “LOW level”.

A signal is then output from the flipflop FFb-2. Since the control signal is in “HIGH level” at this time, the data signal b2 remains in “LOW level”, and thus the drive signal from the output circuit X2 remains in “LOW level”.

The control signal is then turned to “LOW level”. This turns the data signal b2 to “HIGH level”, and thus the drive signal from the output circuit X2 is turned to “HIGH level”.

As described above, the control signal is set so that it stays in “HIGH level” for a predetermined duration within the time period from the time when a data signal is turned to “HIGH level” until the time when the next data signal is turned to “HIGH level”, which is shorter than this time period.

<Effect>

As described above, when one drive signal is being output, output of another drive signal that is essentially unnecessary can be avoided. This can prevent such an occurrence that when an image is being written on one line in a liquid crystal display panel, an image may mistakenly be written on a line adjacent to the line.

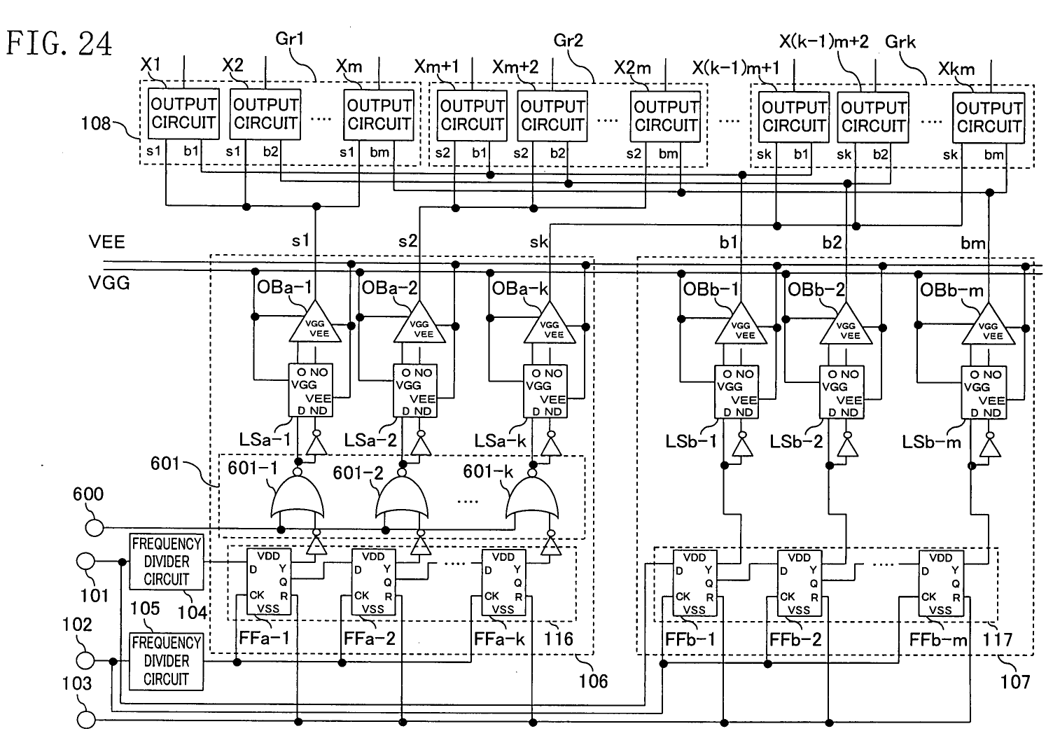

Note that substantially the same effect can also be obtained by connecting the logic circuit 601 between the shift register 116 and the level shifters LSa-1 to LSa-k as shown in FIG. 24. In this case, the logic circuit 601 includes k NOR circuits 601-1 to 601-k.

### SEVENTH EMBODIMENT

### Configuration

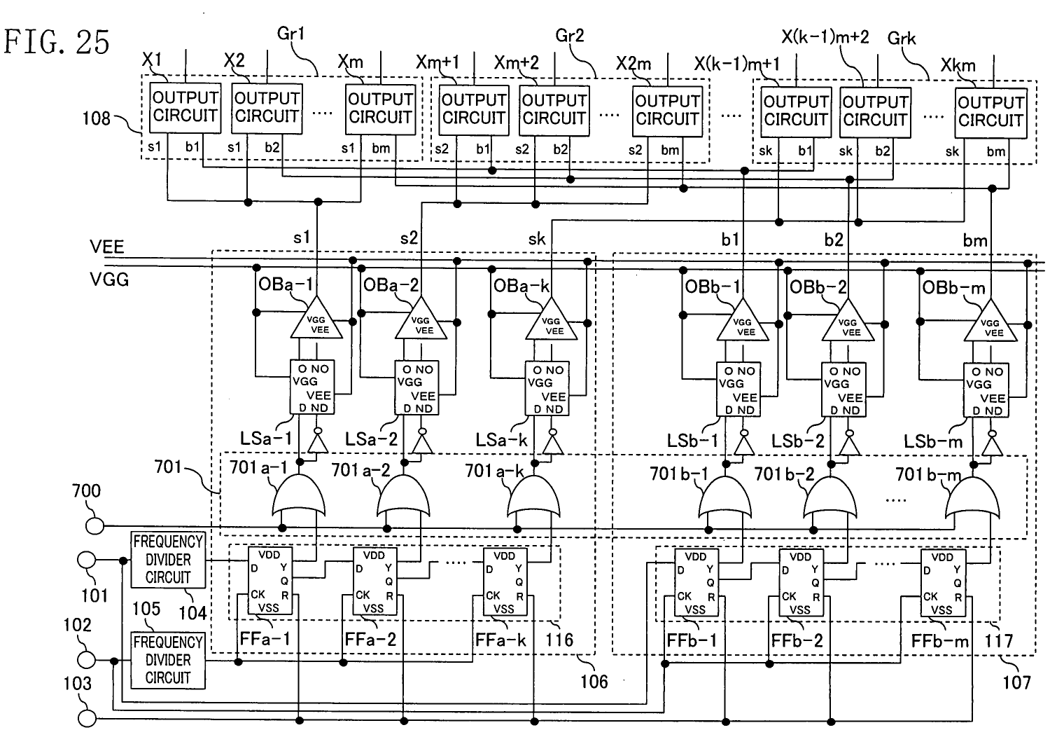

FIG. 25 shows the entire configuration of a drive device of the seventh embodiment of the present invention. This device includes a control signal input terminal 700 and a logic circuit 701 in addition to the components of the drive device shown in FIG. 1. The other configuration is substantially the same as that in FIG. 1. The control signal input terminal 700 receives an external control signal. The logic circuit 701 includes k OR circuits 701a-1 to 701a-k and m OR circuits 701b-1 to 701b-m. Each of the OR circuits 701a-1 to 701a-k receives the control signal from the control signal input terminal 700 and the output from its corresponding flipflop. For example, the OR circuit 701a-1 receives the control signal and the output from the flipflop FFa-1. Each of the OR circuits 701b-1 to 701b-m receives the control signal from the control signal input terminal 700 and the output from its corresponding flipflop. For example, the OR circuit 701b-1 receives the control signal and the output from the flipflop FFb-1.

<Operation>

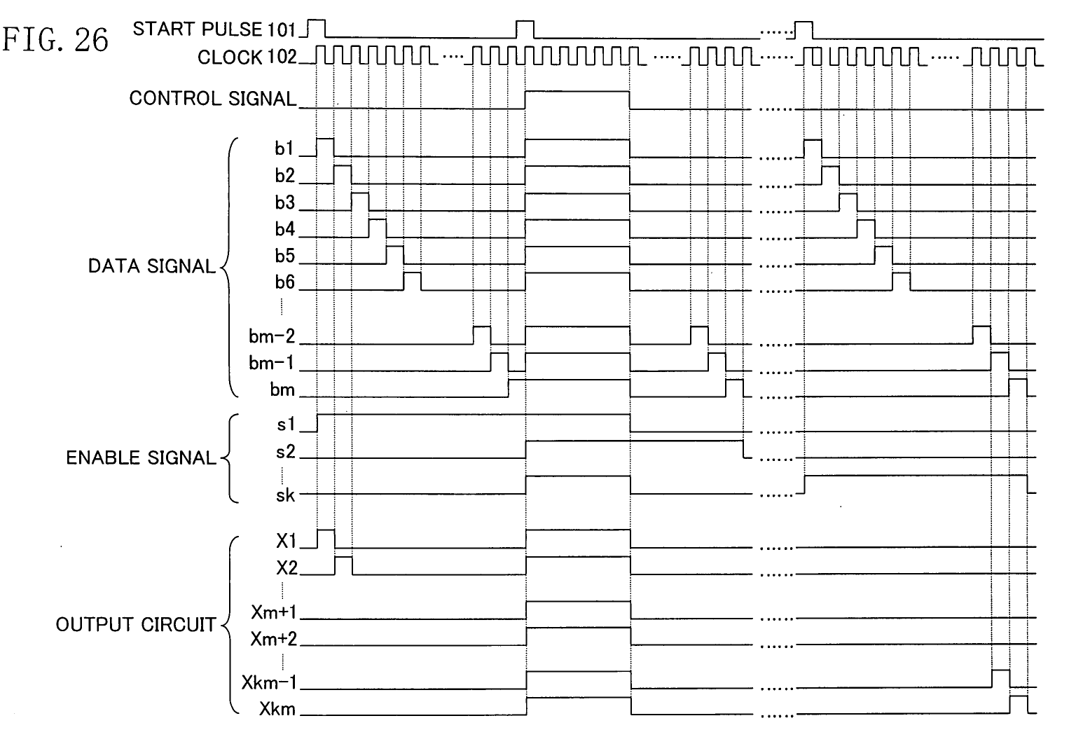

The operation of the drive device shown in FIG. 25 will be described with reference to FIG. 26.

When the control signal is not being input at the control signal input terminal 700 (when the control signal is in “LOW level”), each of the outputs from the shift register 116 is supplied to the corresponding level shifter, to thereby output the enable signals s1 to sk. Also, each of the outputs from the shift register 117 is supplied to the corresponding level shifter, to thereby output the data signals b1 to bm. That is, substantially the same operation as that shown in FIG. 3 is executed.

When the control signal is being input at the control signal input terminal 700 (when the control signal is in “HIGH level”), all the outputs from the k OR circuits 701a-i to 701a-k and all the outputs from the m OR circuits 701b-1 to 701b-m are turned to “HIGH level”. In other words, all the enable signals s1 to sk from the signal generation section 106 are output simultaneously, and all the data signals b1 to bm from the signal generation section 107 are output simultaneously. Hence, drive signals are output from all the output circuits X1 to Xkm simultaneously.

Thus, during the time when the control signal is being input, all the drive signals are output simultaneously.

<Effect>

As described above, all gate lines of a display panel can be activated simultaneously. This allows charge stored in liquid crystal elements of the display panel to be released at a time. Accordingly, for example, the display panel can be swiftly turned off without disturbing the image on the display panel.

### EIGHTH EMBODIMENT

### Entire Configuration

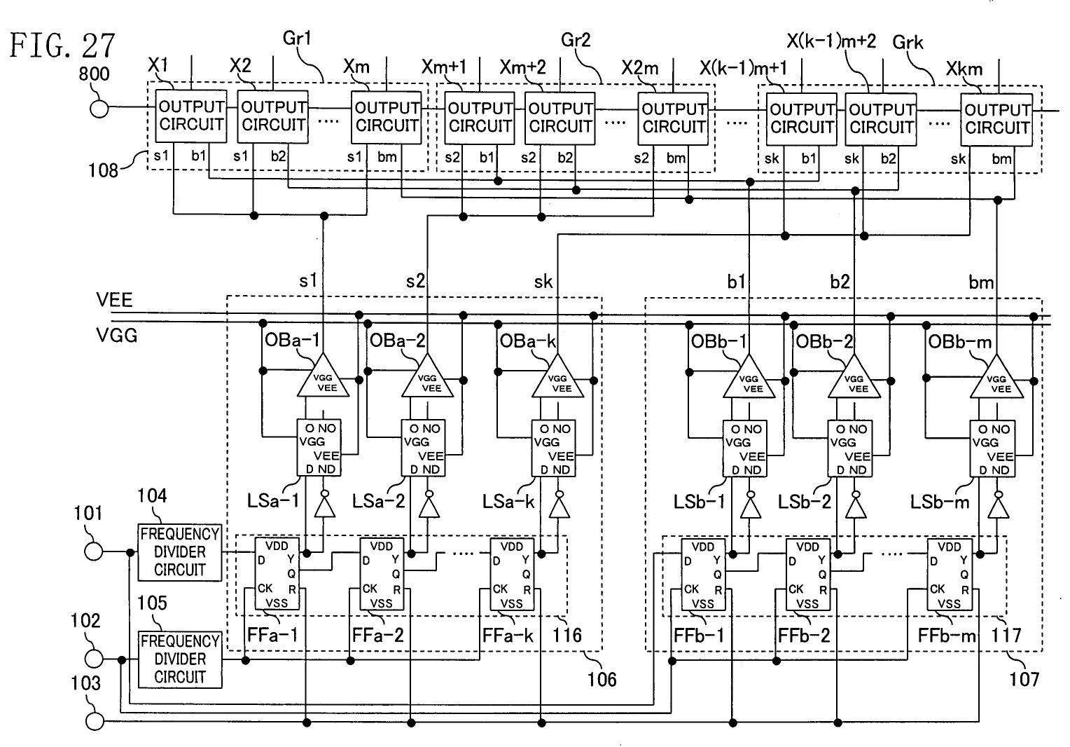

FIG. 27 shows the entire configuration of a drive device of the eighth embodiment of the present invention. This device includes a control signal input terminal 800 in addition to the components of the drive device shown in FIG. 1. Each of the (k×m) output circuits X1 to Xkm receives a control signal input at the control signal input terminal 800. The other configuration is substantially the same as that in FIG. 1.

<Internal Configuration of Selection Circuit>

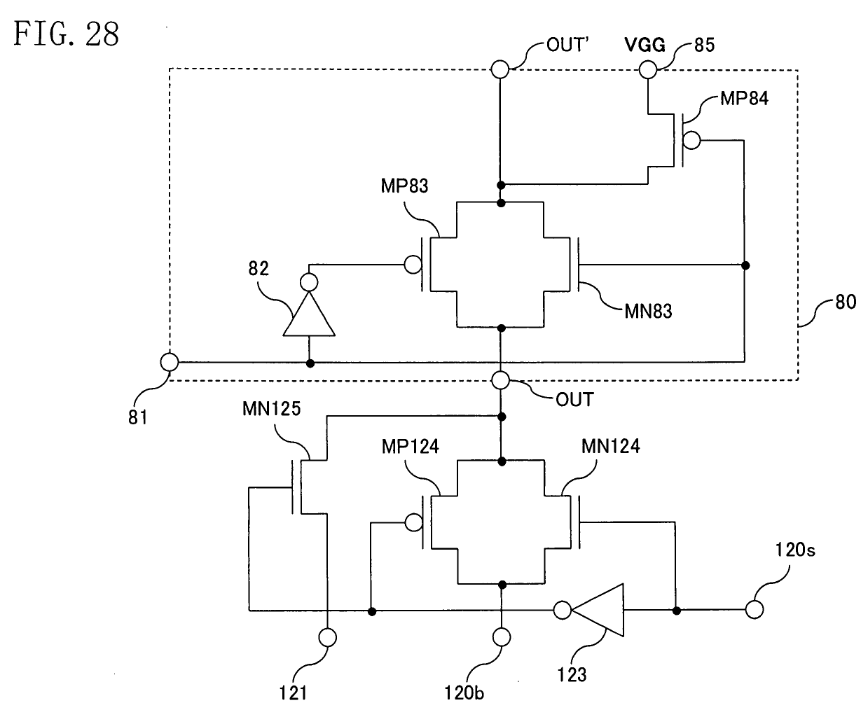

FIG. 28 shows an internal configuration of one of the output circuits shown in FIG. 27. The output circuit includes a selection section 80 in addition to the components of the output circuit shown in FIG. 2. The selection section 80 includes an input terminal 81, an inverter 82, transistors MN83, MP83 and MP84, an output terminal OUT′ and an ON voltage input terminal 85. The input terminal 81 receives the control signal from the control signal input terminal 800. The transistors MN83 and MP83 constitute a transfer gate. The transistor MN83 is connected between the output terminals OUT and OUT′ and receives the control signal from the input terminal 81 at its gate. The transistor MP83 is connected between the output terminals OUT and OUT′ and receives a control signal inverted by the inverter 82 at its gate. The transistor MP84 is connected between the output terminal OUT′ and the ON voltage input terminal 85 and receives the control signal from the input terminal 81 at its gate. The ON voltage input terminal 85 receives the ON voltage VGG.

<Operation>

The operation of the drive device shown in FIG. 27 will be described.

When the control signal is being input at the control signal input terminal 800 (when the control signal is in “HIGH level”), the transistors MN83 and MP83 are in the ON state while the transistor MP84 is in the OFF state. Therefore, the signal (data signal or OFF voltage) supplied at the output terminal OUT is output from the output terminal OUT′. Thus, like the case shown in FIG. 3, each of the output circuits X1 to Xkm outputs a drive signal according to its corresponding enable signal and data signal.

On the contrary, when the control signal is not being input at the control signal input terminal 800 (when the control signal is in “LOW level”), the transistors MN83 and MP83 are in the OFF state while the transistor MP84 is in the ON state. Therefore, the ON voltage VGG, not the signal supplied at the output terminal OUT, is output from the output terminal OUT′. Thus, like the case shown in FIG. 26, all the output circuits X1 to Xkm output drive signals simultaneously.

<Effect>

As described above, all gate lines of a display panel can be activated simultaneously. This allows charge stored in liquid crystal elements of the display panel to be released at a time. Thus, the display panel can be swiftly made “black” over the entire screen.

Also, by making the current capacity of the transistor MP84 weaker than those of the transistors constituting the level shifters and the output buffers (circuits driven with the ON voltage VGG and the OFF voltage VEE), it is possible to prevent occurrence of a sudden flow of charge into interconnections to which the ON voltage VGG has been supplied, and thus prevent corruption of the device. The “current capacity” as used herein refers to the amount of charge flowing through a transistor per unit time. When “the current capacity is weak”, this means that the amount of charge flowing through a transistor per unit time is small.

In the above description of the embodiments, examples of using shift registers each composed of flipflops and frequency dividers were shown to give a circuit for sequentially outputting k signals and a circuit for sequentially outputting m signals. The present invention is not limited to these, but combinations of counters and decoders, for example, may also be used.

Also, m and k should preferably be selected so that the total number of channels “m+k” in the signal generation sections be minimized, to thereby give the highest area reduction effect.

In all of the above embodiments, examples of drive devices for driving scanning lines of liquid crystal panels were described. The present invention is not limited to this, but is also applicable to other display panels such as organic EL panels. Also, the present invention is applicable to any devices adopting active-matrix type drive. Furthermore, the present invention is applicable to one-chip semiconductor integrated circuits configured to sequentially output signals to a plurality of output terminals.

### INDUSTRIAL APPLICABILITY

The drive devices of the present invention, which can reduce the circuit area, are useful as drive devices and drive methods for driving scanning lines in display apparatuses such as liquid crystal display panels and organic EL panels, for example.

1. A drive device comprising:
a first generation section for sequentially turning k first signals from a non-output state to an output state according to a first clock, where k is a natural number;
a second generation section for sequentially turning m second signals from the non-output state to the output state according to a second clock, where m is a natural number; and
(k×m) output circuits divided into k groups,
wherein m output circuits belong to each of the k groups,
the k first signals correspond to the k groups,
the m second signals correspond to the m output circuits belonging to each of the k groups, and
each of the (k×m) output circuits:
outputs its corresponding second signal when the second signal is turned to the output state if the first signal corresponding to the group to which the output circuit belongs is in the output state, and
does not output its corresponding second signal even when the second signal is in the output state if the first signal corresponding to the group to which the output circuit belongs is in the non-output state.

2. The drive device of claim 1, wherein the second generation section sequentially turns the m second signals from the non-output state to the output state according to the second clock during the time when any one of the k first signals is in the output state.

3. The drive device of claim 1, wherein each of the (k×m) output circuits includes:
an output terminal;
a first input terminal for receiving the second signal corresponding to the output circuit;
a first switch connected between the output terminal and the first input terminal for switching ON/OFF according to the state of the first signal corresponding to the output circuit;
a second input terminal for receiving a predetermined voltage corresponding to the non-output state of the second signal, and
a second switch connected between the output terminal and the second input terminal for switching ON/OFF according to the state of the first signal corresponding to the output circuit.

4. The drive device of claim 1, wherein the first generation section includes k first flipflops connected in series, and
the second generation section includes m second flipflops connected in series.

5. The drive device of claim 1, further comprising a logic circuit connected between the first generation section and the (k×m) output circuits and receiving an external control signal,
wherein the logic circuit turns all of the k first signals from the first generation section to the non-output state simultaneously according to existence/absence of the control signal.

6. The drive device of claim 1, further comprising a logic circuit connected between the second generation section and the (k×m) output circuits and receiving an external control signal,
wherein the logic circuit turns all of the m second signals from the second generation section to the non-output state simultaneously according to existence/absence of the control signal.

7. The drive device of claim 4, further comprising:
a first selector connected between the s-th first flipflop from the top and the (s+1)th first flipflop among the k first flipflops, where s is a natural number and 1≦s<(k−2); and
a second selector connected between the t-th first flipflop from the top and the (t+1)th first flipflop among the k first flipflops, where t is a natural number and s<t≦(k−1),
wherein the first and second selectors have first and second modes,
in the first mode, the first selector outputs an output from the s-th first flipflop to the (s+1)th first flipflop, and the second selector outputs an output from the t-th first flipflop to the (t+1)th first flipflop, and
in the second mode, the first selector outputs the output from the s-th first flip-flop to the second selector, and the second selector outputs an output from the first selector to the (t+1)th first flip-flop.

8. The drive device of claim 4, further comprising:
a selection circuit having first and second modes,
wherein in the first mode, the selection circuit outputs an output from the y-th second flipflop from top among the m second flipflops as the y-th second signal, where y is an odd natural number and m is an even natural number, where 1≦y≦(m−1), and outputs an output from the (y+1)th second flipflop as the (y+1)th second signal, and
in the second mode, the selection circuit outputs the output from the y-th second flipflop as the y-th and (y+1)th second signals, and does not output the output from the (y+1)th second flip-flop.

9. The drive device of claim 1, further comprising a logic circuit connected between the first generation section and the (k×m) output circuits and receiving an external control signal,
wherein the logic circuit turns all of the k first signals from the first generation section to the output state simultaneously according to existence/absence of the control signal.

10. The drive device of claim 1, further comprising a logic circuit connected between the second generation section and the (k×m) output circuits and receiving an external control signal,
wherein the logic circuit turns all of the m second signals from the second generation section to the output state simultaneously according to existence/absence of the control signal.

11. The drive device of claim 1, further comprising a logic circuit connected between the first generation section and the (k×m) output circuits and operating according to existence/absence of an external control signal,
wherein the control signal is output for a predetermined duration in the time period from the time when any one of the m second signals is turned to the output state until the time when the next second signal is turned to the output state, the predetermined duration being shorter than the time period, and
once receiving the control signal, the logic circuit turns all of the k first signals from the first generation section to the non-output state simultaneously.

12. The drive device of claim 1, further comprising a logic circuit connected between the second generation section and the (k×m) output circuits and operating according to existence/absence of an external control signal,
wherein the control signal is output for a predetermined duration in the time period from the time when any one of the m second signals is turned to the output state until the time when the next second signal is turned to the output state, the predetermined duration being shorter than the time period, and
once receiving the control signal, the logic circuit turns all of the m second signals from the second generation section to the non-output state simultaneously.

13. The drive device of claim 1, further comprising a logic circuit connected between the first and second generation sections and the (k×m) output circuits and receiving an external control signal,
wherein the logic circuit turns all the k first signals from the first generation section to the output state simultaneously and also turns all the m second signals from the second generation section to the output state simultaneously, according to existence/absence of the control signal.

14. The drive device of claim 3, wherein each of the (k×m) output circuits receives an external control signal, and
the device further comprises a selection section for outputting either the signal supplied at the output terminal or a predetermined voltage corresponding to the output state of the second signal.

15. A drive method for sequentially outputting drive signals from (k×m) output terminals divided into k groups, where k and m are natural numbers, m output terminals belonging to each of the k groups, the method comprising:
sequentially turning k first signals corresponding to the k groups from a non-output state to an output state according to a first clock;
sequentially turning m second signals corresponding to the m output terminals belonging to each of the k groups from the non-output state to the output state according to a second clock; and
in each of the (k×m) output terminals, outputting the second signal corresponding to the output terminal from the output terminal as the drive signal when the second signal is turned to the output state if the first signal corresponding to the group to which the output terminal belongs is in the output state; and
in each of the (k×m) output terminals, not outputting the second signal corresponding to the output terminal from the output terminal as the drive signal even when the second signal is in the output state if the first signal corresponding to the group to which the output terminal belongs is in the non-output state.
